(19) United States
(12) Patent Application Publication
(10) Pub. No.: US 2016/0012542 A1
(43) Pub. Date: Jan. 14, 2016

(54) Systems, Methods, and Apparatus for Hazard Grade Determination for an Insurance Product

(71) Applicant: The Travelers Indemnity Company, Harford, CT (US)

(72) Inventors: Christine L. Steben, Avon, CT (US); Timothy J. Fulton, Spring Grove, PA (US)

(21) Appl. No.: 14/328,869

(22) Filed: Jul. 11, 2014

(51) Int. Cl. G06Q 40/08

(52) U.S. Cl. CPC G06Q 40/08

(57) ABSTRACT

Systems, apparatus, methods, and articles of manufacture provide for determining a hazard grade associated with an insurance product (e.g., for use in calculating a premium for the insurance product). Some embodiments allow for an insurance agent to provide underwriting information and receive a quote based on an automated insurance underwriting process.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Information about potential hazards is commonly considered (e.g., by insurance underwriters of an insurance carrier) in determining whether or not, to what extent, and/or at what price, to offer insurance products to customers (including potential customers and/or renewal customers). Typically, requests for most types of insurance policy coverage must be reviewed by an underwriter for both eligibility and pricing consideration (e.g., based on a comprehensive application). An insurance agent, for example, commonly is required to facilitate the transfer of hazard information associated with a customer to a remote underwriter at an insurance carrier (or the underwriter must otherwise obtain such information) so that the underwriter can manually review the information and rate a desired insurance product. Such practices are typically employed regardless of the size or complexity of the insurance account. Further, quotes provided by agents (if permitted by an insurance carrier) and/or underwriters may vary, even when based on similar information. Despite the importance of appropriately and efficiently linking risk exposure to premium in the insurance arts, previous practices related to the rating of insurance premium based on potential hazards have failed to recognize the inefficiencies, delays, and inconsistencies inherent in requiring the manual participation of underwriters.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is a block diagram of a system according to some embodiments;

FIG. 2 is a flow diagram of a method according to some embodiments;

FIG. 3 is a flow diagram of a method according to some embodiments;

FIG. 4 is a flow diagram of a method according to some embodiments;

FIG. 5 is a diagram of an exemplary risk matrix according to some embodiments;

FIG. 6 is a block diagram of a system according to some embodiments;

FIG. 7 is an example interface according to some embodiments;

FIG. 8 is an example interface according to some embodiments;

FIG. 9 is a block diagram of an example data storage structure according to some embodiments;

FIG. 10 is a block diagram of an example data storage structure according to some embodiments;

FIG. 11 is a flow diagram of a method according to some embodiments; and

FIG. 12 is a block diagram of an apparatus according to some embodiments.

### DETAILED DESCRIPTION

Embodiments described herein are descriptive of systems, apparatus, methods, interfaces, and articles of manufacture for account-level risk assessment. In some embodiments, for example, risk attributes associated with errors and omissions policy coverage for an insurance account may be analyzed to determine, replace, and/or modify a risk assessment (also referred to in this disclosure as a “hazard grade” (HG)).

A hazard grade, in some embodiments, may describe an assessment of risk of an account as a whole (e.g., an account-level HG), a particular type or category of risk (e.g., a product complexity HG), and/or a particular item of information (e.g., a question HG score associated with a particular underwriting question).

As described in this disclosure, a hazard grade system may include any type of ranking or rating system, and may be based on any combination of relative ordinal and/or numeric values suitable for a desired implementation. In one example, a hazard grade may be associated with a relative term (e.g., “High”, “Medium”, “Low”; “A”, “B”, “C”) and/or with a particular numerical value (e.g., 0, 1.7, 99). For instance, an HG score of “12” (e.g., for a particular underwriting question for E&O coverage) may correspond to a hazard grade of “High”.

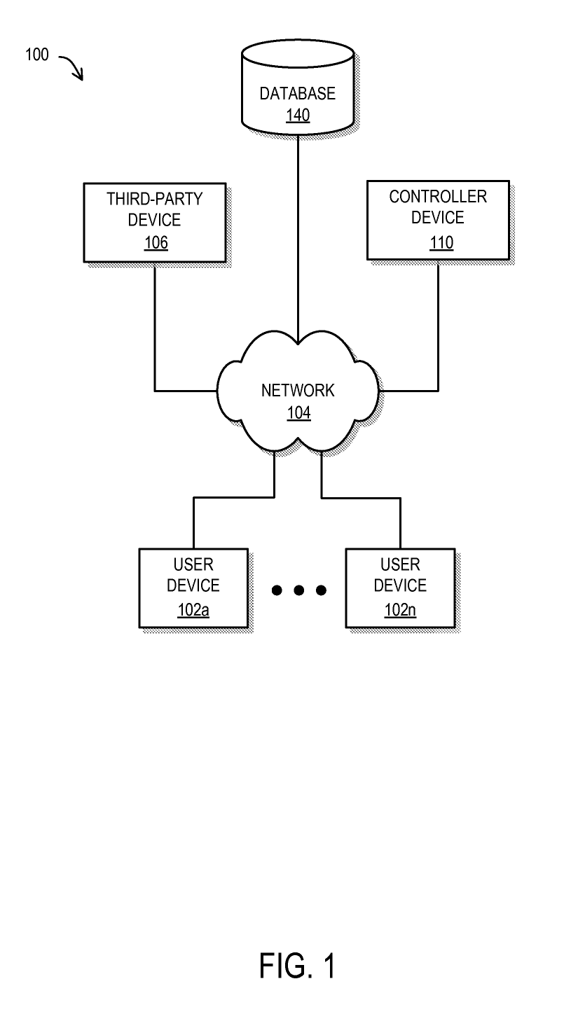

Referring first to FIG. 1, a block diagram of a system 100 according to some embodiments is shown. In some embodiments, the system 100 may comprise a plurality of user devices 102a-n, a network 104, a third-party device 106, and/or a controller device 110. As depicted in FIG. 1, any or all of the devices 102a-n, 106, 110 (or any combinations thereof) may be in communication via the network 104. In some embodiments, the system 100 may be utilized to provide (and/or receive) E&O risk, building (and/or structure), and/or other data or metrics. The controller device 110 may, for example, interface with one or more of the user devices 102a-n and/or the third-party device 106 to acquire, gather, aggregate, process, and/or utilize E&O risk, building (and/or structure), and/or other data or metrics in accordance with embodiments described in this disclosure.

Fewer or more components 102a-n, 104, 106, 110 and/or various configurations of the depicted components 102a-n, 104, 106, 110 may be included in the system 100 without deviating from the scope of embodiments described herein. In some embodiments, the components 102a-n, 104, 106, 110 may be similar in configuration and/or functionality to similarly named and/or numbered components as described herein. In some embodiments, the system 100 (and/or portion thereof) may comprise a risk assessment and/or underwriting program and/or platform programmed and/or otherwise configured to execute, conduct, and/or facilitate any of the various methods and/or portions or combinations thereof described herein.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., underwriter workstations), tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as underwriters, account managers, agents/brokers, customer service representatives, data acquisition partners and/or consultants or service providers, and/or underwriting product customers. According to some embodiments, the user devices 102a-n may communicate with the controller device 110 via the network 104, such as to conduct underwriting inquiries and/or processes utilizing E&O risk factors and/or building (and/or structure) data as described herein.

In some embodiments, the user devices 102a-n may interface with the controller device 110 to effectuate communications (directly and/or indirectly) with one or more other user devices 102a-n (such communication not explicitly shown in FIG. 1), such as may be operated by other users. In some embodiments, the user devices 102a-n may interface with the controller device 110 to effectuate communications (direct or indirect) with the third-party device 106 (such communication also not explicitly shown in FIG. 1). In some embodiments, the user devices 102a-n and/or the third-party device 106 may comprise one or more servers and/or controller devices configured and/or coupled to calculate and/or otherwise process or determine E&O risk and/or building (and/or structure) data. In some embodiments, such sensor data may be provided to the controller device 110, such as for utilization of the E&O risk and/or building (and/or structure) data in pricing, risk assessment, line and/or limit setting, quoting, and/or selling or re-selling an underwriting product.

The network 104 may, according to some embodiments, comprise a Local Area Network (LAN; wireless and/or wired), cellular telephone, Bluetooth®, and/or Radio Frequency (RF) network with communication links between the controller device 110, the user devices 102a-n, and/or the third-party device 106. In some embodiments, the network 104 may comprise direct communications links between any or all of the components 102a-n, 106, 110 of the system 100. The user devices 102a-n may, for example, be directly interfaced or connected to one or more of the controller device 110 and/or the third-party device 106 via one or more wires, cables, wireless links, and/or other network components, such network components (e.g., communication links) comprising portions of the network 104. In some embodiments, the network 104 may comprise one or many other links or network components other than those depicted in FIG. 1. The user devices 102a-n may, for example, be connected to the controller device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks deemed practicable for a particular implementation. According to some embodiments, the network 104 may comprise a conglomeration of different sub-networks and/or network components interconnected, directly or indirectly, by the components 102a-n, 106, 110 of the system 100. The network 104 may comprise one or more cellular telephone networks with communication links between the user devices 102a-n and the controller device 110, for example, and/or may comprise the Internet, with communication links between the controller device 110 and the third-party device 106, for example.

The third-party device 106, in some embodiments, may comprise any type or configuration of computerized processing device(s) such as a PC, laptop computer, computer server, database system, and/or other electronic device, devices, or any combination thereof. In some embodiments, the third-party device 106 may be owned and/or operated by a third-party (i.e., an entity different than any entity owning and/or operating either the user devices 102a-n or the controller device 110). The third-party device 106 may, for example, be owned and/or operated by a data and/or data service provider. In some embodiments, the third-party device 106 may supply and/or provide data such as E&O risk and/or building (and/or structure) and/or other data to the controller device 110 and/or the user devices 102a-n. In some embodiments, the third-party device 106 may comprise a plurality of devices and/or may be associated with a plurality of third-party entities.

In some embodiments, the controller device 110 may comprise an electronic and/or computerized controller device, such as a computer server communicatively coupled to interface with the user devices 102a-n and/or the third-party device 106 (directly and/or indirectly). The controller device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 110 may be located remote from one or more of the user devices 102a-n and/or the third-party device 106. The controller device 110 may also or alternatively comprise a plurality of electronic processing devices located at one or more various sites and/or locations.

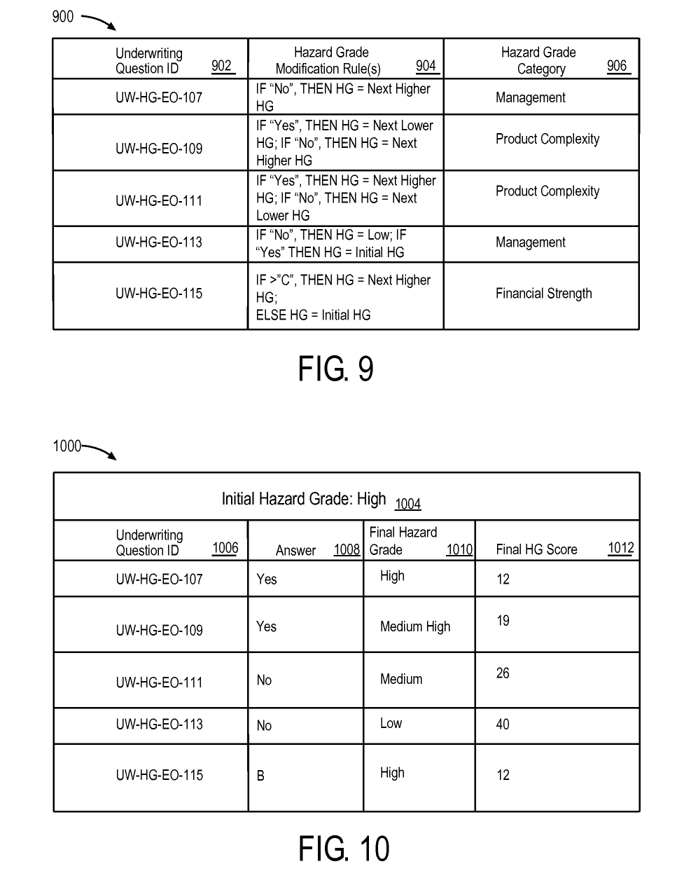

According to some embodiments, the controller device 110 may store and/or execute specially programmed instructions to operate in accordance with embodiments described herein. The controller device 110 may, for example, execute one or more programs that facilitate the utilization of E&O risk and/or building (and/or structure) data in the pricing, underwriting, and/or issuance of one or more insurance and/or underwriting products. According to some embodiments, the controller device 110 may comprise a computerized processing device such as a PC, laptop computer, computer server, and/or other electronic device to manage and/or facilitate transactions and/or communications regarding the user devices 102a-n. An underwriter (and/or customer, client, or company) may, for example, utilize the controller device 110 to (i) price and/or underwrite one or more products such as insurance, indemnity, and/or surety products, (ii) determine and/or be provided with E&O risk and/or building (and/or structure) and/or other information, and/or (iii) provide an interface via which an underwriting entity may manage and/or facilitate underwriting of various products (e.g., in accordance with embodiments described herein; such as the example interfaces 920a-b of FIG. 9A and/or FIG. 9B).

In one or more embodiments a user device 102a comprises a device owned and/or operated by an insurance agent/broker in communication with controller device 110 owned and/or operated by an insurance carrier via the network 104. Accordingly, in some embodiments the configuration of system 100 applies a technical solution (facilitated by one or more types of specific computing devices described in this disclosure) and substantially limited to addressing particular problems in the insurance arts. For example, in accordance with some embodiments, the system 100 may allow an insurance agent/broker to initiate, remotely and without the participation of another user (e.g., without the participation and associated potential delay and/or inconsistency of a remote underwriter manually reviewing an application file), an automated underwriting inquiry and/or process assessing risk with respect to E&O and/or building (and/or structure) data as described herein. In some embodiments, utilizing an automated underwriting platform (e.g., controlled by controller device 110) an agent/broker may be able to secure a quote (e.g., rated based on E&O and/or other types of risk) and issue an E&O policy, without the participation of a remote human underwriter.

The process diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, data storage device, Random Access Memory (RAM) device, cache memory device, Universal Serial Bus (USB) mass storage device, and/or Digital Video Disk (DVD)) may store thereon instructions that when executed by a machine (such as a computerized processor) result in performance according to any one or more of the embodiments described herein.

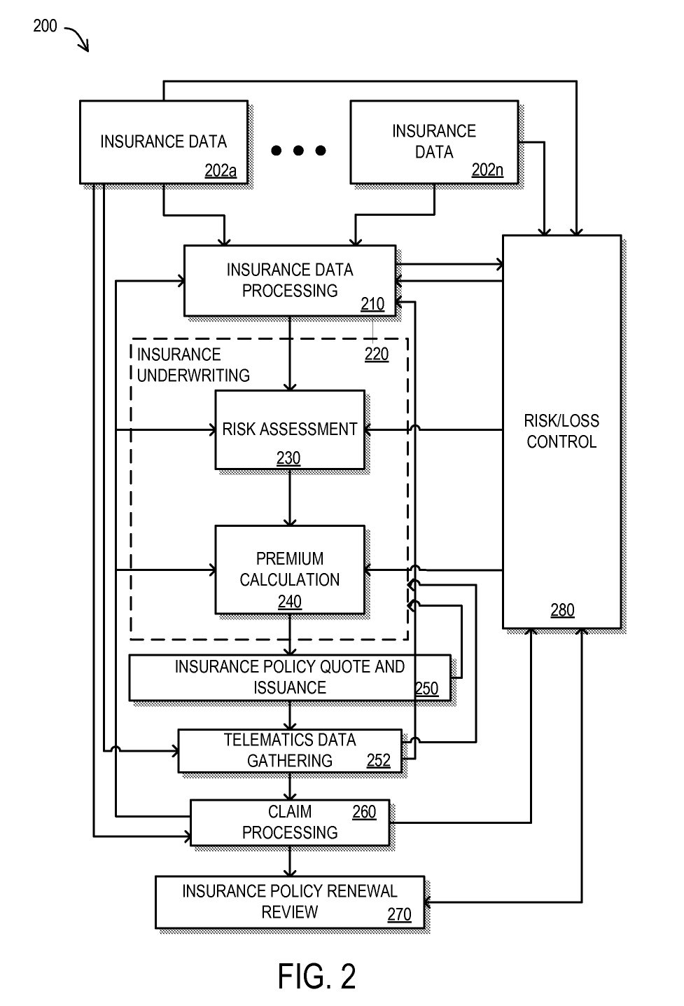

Referring now to FIG. 2, a flow diagram of a method 200 according to some embodiments is shown. In some embodiments, the method 200 may be performed and/or implemented by and/or otherwise associated with one or more specialized and/or specially-programmed computers (e.g., the user devices 102a-n, the third-party device 106, and/or the controller device 110, all of FIG. 1), computer terminals, computer servers, computer systems and/or networks, and/or any combinations thereof (e.g., by one or more insurance company and/or underwriter computers).

According to some embodiments, the method 200 may comprise one or more actions associated with insurance data 202a-n. The insurance data 202a-n of one or more objects and/or areas that may be related to and/or otherwise associated with an insurance territory, account, customer, insurance product and/or policy, for example, may be determined, calculated, looked-up, retrieved, and/or derived. In some embodiments, the insurance data 202a-n may be gathered as raw data directly from one or more data sources.

As depicted in FIG. 2, insurance data 202a-n from a plurality of data sources may be gathered. In some embodiments, the insurance data 202a-n may comprise information indicative of various types of perils, risks, geo-spatial data, business data, customer and/or consumer data, and/or other data that is or becomes useful or desirable for the conducting of risk assessment and/or underwriting processes. The insurance data 202a-n may comprise, for example, business location data, business classification data (e.g., acquired and/or derived from one or more third-party sources), business characteristic data (e.g., annual sales, receipts, payroll, square footage of business operations space), etc. The insurance data 202a-n may be acquired from any quantity and/or type of available source that is desired and/or practicable, such as from one or more users, interfaces, sensors, databases, and/or third-party devices. In some embodiments, the insurance data 202a-n may comprise geospatial and/or geo-coded data relating various peril metrics to one or more geographic locations. In some embodiments, the insurance data 202a-n may comprise business classification risk, ranking, and/or scoring data utilized to effectuate business classification.

In some embodiments, the insurance data 202a-n may comprise risk data that may be descriptive of business practices data, litigation data, product and/or services data associated with a business, etc., which may be utilized to effectuate risk assessment for one or more types of coverage (e.g., for an E&O policy). According to some embodiments, risk data may describe one or more of the following types of information:
information representative of the management or control of a business
information descriptive of the complexity of a business's products and/or services
financial information
an assessment of a business's financial strength (e.g. a financial score from a third-party service provider, such as a Dun & Bradstreet™ (D&B) score from Dun & Bradstreet)
contract practices information (e.g., information about a business's contract review process)
contract information (e.g., contract values, contract provisions, etc.)
litigation information (e.g., information about lawsuits in which a business is or has been involved)
product and/or service information (e.g., information about the types of goods and services provided by a business, an indication of susceptibility of a product to defect)
contingency plan information (e.g., information about whether a business has a plan to implement in the event of a data breach and/or information about such a plan))
customer impact information (e.g., information describing the effect on customers as a result of one or more types of events, such as the unavailability of a business's product, website and/or other types of goods or services)
prior loss history information
business longevity information (e.g., an indication of how long a business has been in operation)

According to some embodiments, the method 200 may also or alternatively comprise one or more actions associated with insurance data processing 210. As depicted in FIG. 2, for example, some or all of the insurance data 202a-n may be determined, gathered, transmitted and/or received, and/or otherwise obtained for insurance data processing 210. In some embodiments, insurance data processing 210 may comprise aggregation, analysis, calculation, filtering, conversion, encoding and/or decoding (including encrypting and/or decrypting), sorting, ranking, de-duping, and/or any combinations thereof.

According to some embodiments, a processing device may execute specially programmed instructions to process (e.g., the insurance data processing 210) the insurance data 202a-n to define one or more business classifications applicable to a business and/or to select a business classification from a plurality of possible and/or applicable business classifications. Details on systems and methods for determining a business classification are provided in commonly-assigned U.S. patent application Ser. No. 13/179,464, entitled “SYSTEMS AND METHODS FOR BUSINESS CLASSIFICATION,” filed on Jul. 8, 2011, and in commonly-assigned U.S. patent application Ser. No. ______ (Attorney Docket No. TR01-048-01), entitled “SYSTEMS AND METHODS FOR BUSINESS RECLASSIFICATION TIEBREAKING”, filed on Jul. 11, 2014, the risk assessment concepts and descriptions of which are hereby incorporated by reference herein.

In some embodiments, the method 200 may also or alternatively comprise one or more actions associated with insurance underwriting 220. Insurance underwriting 220 may generally comprise any type, variety, and/or configuration of underwriting process and/or functionality that is or becomes known or practicable. Insurance underwriting 220 may comprise, for example, determining, accessing, and/or receiving a pre-existing rule, criteria, and/or threshold to determine, based on any relevant insurance data 202a-n (e.g., E&O risk data), if an insurance product (e.g., an E&O policy) may be offered, underwritten, and/or issued (e.g., to a customer). According to one more embodiments, the insurance underwriting process 220 may comprise one or more of a risk assessment 230 and/or a premium calculation 240, as shown in FIG. 2. In some embodiments, while both the risk assessment process 230 and the premium calculation process 240 are depicted as being part of an exemplary insurance underwriting process 220, either or both of the risk assessment 230 and the premium calculation 240 may alternatively be part of a different process and/or different type of process (and/or may not be included in the method 200), as deemed practicable and/or desirable for a desired implementation. In some embodiments, the insurance data 202a-n may be utilized in the insurance underwriting 220 and/or portions or processes thereof. The insurance data 202a-n may be utilized, at least in part, in one example, to determine, define, identify, recommend, and/or select a coverage type and/or limit and/or type and/or configuration of underwriting product (e.g., an E&O insurance policy coverage).

In some embodiments, the insurance data 202a-n and/or a result of the insurance data processing 210 may be determined and utilized to conduct the risk assessment 230 for any of a variety of purposes. In some embodiments, the risk assessment 230 may be conducted as part of a rating process for determining how to structure an insurance product and/or offering.

In one or more embodiments, a “risk rating engine” utilized in an insurance underwriting process may, for example, generate, retrieve, or otherwise determine one or more hazard grades (e.g. for an insurance account). In some embodiments, risk assessment 230 may comprise determining a hazard grade associated with an insurance account based on information derived from insurance data processing 210 (e.g., a business classification based on insurance data 202a-n) and/or based on one or more types of desired insurance coverage (e.g., general liability insurance, property insurance, E&O insurance). For example, risk assessment 230 may determine a hazard grade for an insurance account with a general liability policy based on a business's classification (e.g., business operation type, such as indicated by an applicable Standard Industrial Classification (SIC) code). In some embodiments, a risk rating engine may, for example, utilize one or more calculations and/or mathematical models to determine a hazard grade or other type of risk assessment representative of the amount of risky behavior and/or events likely to be associated with a particular business, building, object, and/or location.

In one or more embodiments, risk assessment 230 may determine a first hazard grade based on first insurance data (e.g., a business's classification and/or location) and determine a second hazard grade based on second insurance data (e.g., E&O data, answers to coverage-specific underwriting questions). In one or more embodiments, risk assessment 230 may comprise determining a first hazard grade based on a first type of insurance coverage (e.g., general liability) and subsequently modifying, adjusting, replacing, or confirming the first hazard grade (e.g., determining a second hazard grade that may be the same as or different than the first hazard grade) based on second type of insurance coverage (e.g., in response to a user's selection of an E&O coverage option).

In some embodiments, an insurance underwriting process may comprise receiving, acquiring, or otherwise determining additional insurance information (e.g., in addition to insurance data 202a-n) based on one or more selected insurance coverages (e.g., based on a user's selection of an E&O coverage option). As described in this disclosure with respect to various embodiments, one or more users may provide insurance information via one or more types of user interfaces (e.g., an insurance agent/broker may submit responses to one or more types of underwriting questions associated with a specific insurance coverage).

In some embodiments, the risk assessment 230 (and/or the method 200) may comprise providing risk control recommendations (e.g., recommendations and/or suggestions directed to reduction of risk, premiums, loss, etc.).

According to some embodiments, the method 200 may also or alternatively comprise one or more actions associated with premium calculation 240 (e.g., which may be part of the insurance underwriting 220). In the case that the method 200 comprises insurance underwriting 220, for example, the premium calculation 240 may be utilized by a “pricing engine” to calculate (and/or look-up or otherwise determine) an appropriate premium to charge for an insurance policy associated with the object and/or area for which the insurance data 202a-n was collected and for which the risk assessment 230 was performed. In some embodiments, premium calculation 240 may utilize a hazard grade or other type of risk assessment in determining an appropriate premium. According to some embodiments, one or more components of a pricing calculation may be based on a hazard grade. In one example, a hazard grade (e.g., “High”) associated with an insurance account may correspond to a particular base rate (e.g., “1.13”) or other type of premium calculation component used to calculate a premium.

In some embodiments, the object and/or area analyzed may comprise an object and/or area for which an insurance product is sought (e.g., the analyzed object may comprise a property for which a property insurance policy is desired or a business for which business insurance is desired). According to some embodiments, the object and/or area analyzed may be an object and/or area other than the object and/or area for which insurance is sought.

According to some embodiments, the method 200 may also or alternatively comprise one or more actions associated with insurance policy quote and/or issuance 250. Once a policy has been rated, priced, or quoted (e.g., in accordance with an automatically-determined business classification, such as a result of a business classification tiebreaking process) and the customer/client has accepted the coverage terms, the insurance company may, for example, bind and issue the policy by hard copy and/or electronically to the client/insured. In some embodiments, the quoted and/or issued policy may comprise a personal insurance policy, such as a property damage and/or liability policy, and/or a business insurance policy, such as a business liability policy, and/or a property damage policy.

In general, a client/customer may visit a website and/or an insurance agent, for example, provide the needed information about the client and type of desired insurance, and request an insurance policy and/or product. According to some embodiments, the insurance underwriting 220 may be performed utilizing information about the potential client and the policy may be issued as a result thereof. Insurance coverage may, for example, be evaluated, rated, priced, and/or sold to one or more clients, at least in part, based on the insurance data 202a-n.

In some embodiments, an insurance company may have the potential client indicate electronically, on-line, or otherwise whether they have any peril-sensing and/or location-sensing (e.g., telematics) devices (and/or which specific devices they have) and/or whether they are willing to install them or have them installed. In some embodiments, this may be done by check boxes, radio buttons, or other form of data input/selection, on a web page and/or via a mobile device application. In some embodiments, the method 200 may comprise telematics data gathering, at 252. In the case that a client desires to have telematics data monitored, recorded, and/or analyzed, for example, not only may such a desire or willingness affect policy pricing (e.g., affect the premium calculation 240), but such a desire or willingness may also cause, trigger, and/or facilitate the transmitting and/or receiving, gathering, retrieving, and/or otherwise obtaining insurance data 202a-n from one or more telematics devices. As depicted in FIG. 2, results of the telematics data gathering at 252 may be utilized to affect the insurance data processing 210, the risk assessment 230, and/or the premium calculation 240 (and/or otherwise may affect the insurance underwriting 220).

According to some embodiments, the method 200 may also or alternatively comprise one or more actions associated with claims 260. In the insurance context, for example, after an insurance product is provided and/or policy is issued (e.g., via insurance policy quote and issuance 250), and/or during or after telematics data gathering 252, one or more insurance claims 260 may be filed against the product/policy. In some embodiments, such as in the case that a first object associated with the insurance policy is somehow involved with one or more insurance claims 260, the insurance data 202a-n of the object or related objects may be gathered and/or otherwise obtained. According to some embodiments, such insurance data 202a-n may comprise data indicative of a level of risk of the object and/or area (or area in which the object was located) at the time of casualty or loss (e.g., as defined by the one or more claims 260). Information on claims 260 may be provided to the insurance data processing 210, risk assessment 230, and/or premium calculation 240 to update, improve, and/or enhance these procedures and/or associated software and/or devices. In some embodiments, insurance data 202a-n may be utilized to determine, inform, define, and/or facilitate a determination or allocation of responsibility related to a loss (e.g., the insurance data 202a-n may be utilized to determine an allocation of weighted liability amongst those involved in the incident(s) associated with the loss).

In some embodiments, the method 200 may also or alternatively comprise insurance policy renewal review 270. Insurance data 202a-n (e.g., associated business classification and/or E&O data) may be utilized, for example, to determine if and/or how an existing insurance policy (e.g., provided via the insurance policy quote and issuance 250) may be renewed. According to some embodiments, such as in the case that a client is involved with and/or in charge of (e.g., responsible for) providing the insurance data 202a-n (e.g., such as location data indicative of one or more particular property, building, and/or structure attributes), a review may be conducted to determine if the correct amount, frequency, and/or type or quality of the insurance data 202a-n was indeed provided by the client during the original term of the policy. In the case that the insurance data 202a-n was lacking, the policy may not, for example, be renewed and/or any discount received by the client for providing the insurance data 202a-n may be revoked or reduced.

In some embodiments, the client may be offered a discount for having certain sensing devices or being willing to install them or have them installed (or be willing to adhere to certain thresholds based on measurements from such devices). In some embodiments, analysis of the received insurance data 202a-n in association with the policy may be utilized to determine if the client conformed to various criteria and/or rules set forth in the original policy. In the case that the client satisfied applicable policy requirements (e.g., as verified by received insurance data 202a-n), the policy may be eligible for renewal and/or discounts. In the case that deviations from policy requirements are determined (e.g., based on the insurance data 202a-n), the policy may not be eligible for renewal, a different policy may be applicable, and/or one or more surcharges and/or other penalties may be applied.

According to some embodiments, the method 200 may comprise one or more actions associated with risk/loss control 280. Any or all data (e.g., insurance data 202a-n and/or other data) gathered as part of a process for claims 260, for example, may be gathered, collected, and/or analyzed to determine how (if at all) one or more of a risk rating engine (e.g., utilized by risk assessment 230), a pricing engine (e.g., utilized by premium calculation 240), insurance underwriting 220, and/or insurance data processing 210, should be updated to reflect actual and/or realized risk, costs, and/or other issues associated with the insurance data 202a-n. Results of the risk/loss control 280 may, according to some embodiments, be fed back into the method 200 to refine risk assessment 230, premium calculation 240 (e.g., for subsequent insurance queries and/or calculations), insurance policy renewal review 270 (e.g., a re-calculation of an existing policy for which the one or more claims 260 were filed), and/or the insurance data processing 210 to appropriately scale the output of the risk assessment 230.

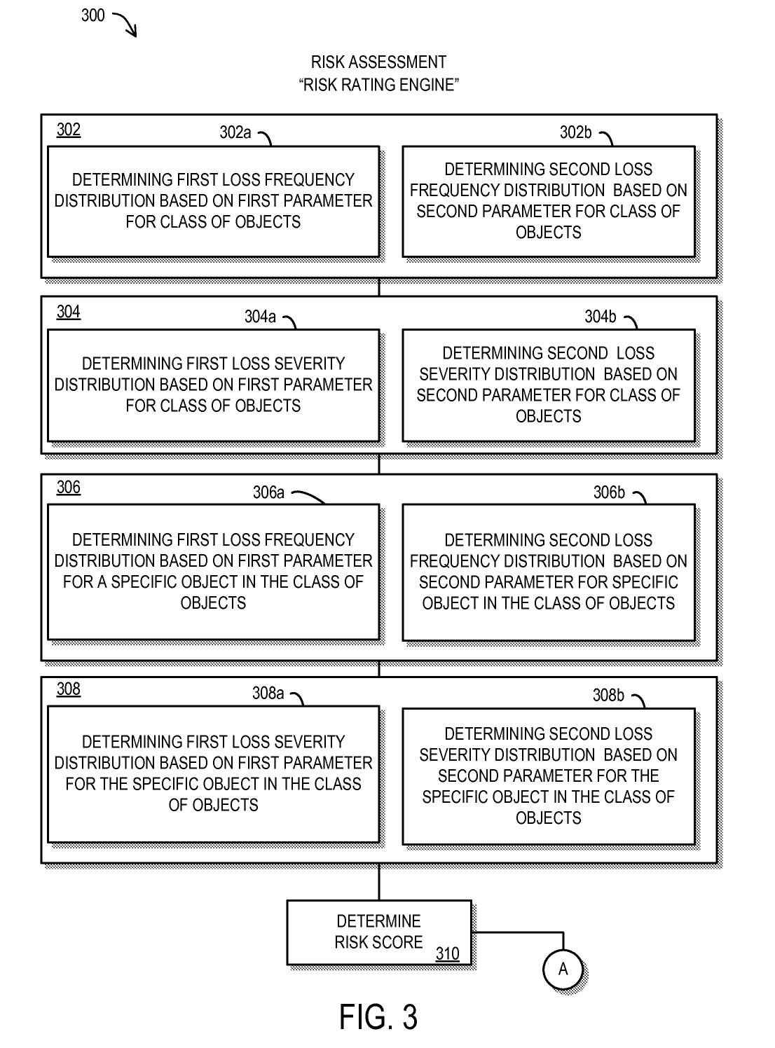

Referring now to FIG. 3, a flow diagram of a method 300 according to some embodiments is shown. In some embodiments, the method 300 may comprise one or more risk assessment methods which may, for example, be described as a “risk rating engine”. According to some embodiments, the method 300 may be implemented, facilitated, and/or performed by or otherwise associated with the systems described herein. In some embodiments, the method 300 may be associated with the method 200 of FIG. 2. The method 300 may, for example, comprise a portion of the method 200, such as risk assessment 230.

According to some embodiments, the method 300 may comprise determining one or more loss frequency distributions for a class of objects, at 302 (e.g., 302a-b). In some embodiments, a first loss frequency distribution may be determined, at 302a, based on a first parameter, data and/or metrics. Insurance data (such as the insurance data 202a-n of FIG. 2 and/or a portion thereof) for a class of objects such as a class of business and/or for a particular type of business (such as an IT networking services company) within a class of objects (such as IT services) may, for example, be analyzed to determine relationships between various data and/or metrics and empirical data descriptive of actual insurance losses for such business types and/or classes of business. A risk processing and/or analytics system and/or device (e.g., the controller device 110 as described with respect to FIG. 1 herein) may, according to some embodiments, conduct regression and/or other mathematical analysis on various risk metrics to determine and/or identify mathematical relationships that may exist between such metrics and actual sustained losses and/or casualties.

Similarly, at 302b, a second loss frequency distribution may be determined based on a second parameter for the class of objects. According to some embodiments, the determining at 302b may comprise a standard or typical loss frequency distribution utilized by an entity (such as an insurance company) to assess risk. The second parameter and/or parameters utilized as inputs in the determining at 302b may include, for example, age of a building, proximity to emergency services, etc. In some embodiments, the loss frequency distribution determinations at 302a-b may be combined and/or determined as part of a single comprehensive loss frequency distribution determination. In such a manner, for example, expected total loss probabilities (e.g., taking into account both first parameter and second parameter data) for a particular object type and/or class may be determined. In some embodiments, this may establish and/or define a baseline, datum, average, and/or standard with which individual and/or particular risk assessments may be measured.

According to some embodiments, the method 300 may comprise determining one or more loss severity distributions for a class of objects, at 304 (e.g., 304a-b). In some embodiments, a first loss severity distribution may be determined, at 304a, based on the first parameter for the class of objects. Business classification data (such as the insurance data 202a-n of FIG. 2) for a class of objects such as location objects and/or for a particular type of object (such as a dry cleaning business) may, for example, be analyzed to determine relationships between various first parameter metrics and empirical data descriptive of actual insurance losses for such object types and/or classes of objects. A risk processing and/or analytics system (e.g., the controller device 110 as described with respect to FIG. 1) may, according to some embodiments, conduct regression and/or other analysis on various metrics to determine and/or identify mathematical relationships that may exist between such metrics and actual sustained losses and/or casualties.

Similarly, at 304b, a second loss severity distribution may be determined based on the second parameter for the class of objects. According to some embodiments, the determining at 304b may comprise a standard or typical loss severity distribution utilized by an entity (such as an insurance agency) to assess risk. The second parameter and/or parameters utilized as inputs in the determining at 304b may include, for example, cost of replacement or repair, ability to self-mitigate loss (e.g., if a business has a response plan for managing a data breach event), etc. In some embodiments, the loss severity distribution determinations at 304a-b may be combined and/or determined as part of a single comprehensive loss severity distribution determination. In such a manner, for example, expected total loss severities (e.g., taking into account both first parameter and second parameter data) for a particular object type and/or class may be determined. In some embodiments, this may also or alternatively establish and/or define a baseline, datum, average, and/or standard with which individual and/or particular risk assessments may be measured.

In some embodiments, the method 300 may comprise determining one or more expected loss frequency distributions for a specific object (and/or account or other group of objects) in the class of objects, at 306 (e.g., 306a-b). Regression and/or other mathematical analysis performed on the first parameter loss frequency distribution derived from empirical data, at 302a for example, may identify various first parameter metrics and may mathematically relate such metrics to expected loss occurrences (e.g., based on historical trends). Based on these relationships, a first parameter loss frequency distribution may be developed at 306a for the specific object (and/or account or other group of objects). In such a manner, for example, known first parameter metrics for a specific object (and/or account or other group of objects) may be utilized to develop an expected distribution (e.g., probability) of occurrence of first parameter-related loss for the specific object (and/or account or other group of objects).

Similarly, regression and/or other mathematical analysis performed on the second parameter loss frequency distribution derived from empirical data, at 302b for example, may identify various second parameter metrics and may mathematically relate such metrics to expected loss occurrences (e.g., based on historical trends). Based on these relationships, a second parameter loss frequency distribution may be developed at 306b for the specific object (and/or account or other group of objects). In such a manner, for example, known second parameter metrics for a specific object may be utilized to develop an expected distribution (e.g., probability) of occurrence of second parameter-related loss for the specific object (and/or account or other group of objects). In some embodiments, the second parameter loss frequency distribution determined at 306b may be similar to a standard or typical loss frequency distribution utilized by an insurer to assess risk.

In some embodiments, the method 300 may comprise determining one or more expected loss severity distributions for a specific object (and/or account or other group of objects) in the class of objects, at 308 (e.g., 308a-b). Regression and/or other mathematical analysis performed on the first parameter loss severity distribution derived from empirical data, at 304a for example, may identify various first parameter risk metrics and may mathematically relate such metrics to expected loss severities (e.g., based on historical trends). Based on these relationships, a first parameter loss severity distribution may be developed at 308a for the specific object (and/or account or other group of objects). In such a manner, for example, known first parameter metrics for a specific object (and/or account or other group of objects) may be utilized to develop an expected severity for occurrences of first parameter-related loss for the specific object (and/or account or other group of objects).

Similarly, regression and/or other mathematical analysis performed on the second parameter loss severity distribution derived from empirical data, at 304b for example, may identify various second parameter metrics and may mathematically relate such metrics to expected loss severities (e.g., based on historical trends). Based on these relationships, a second parameter loss severity distribution may be developed at 308b for the specific object (and/or account or other group of objects). In such a manner, for example, known second parameter metrics for a specific object (and/or account or other group of objects) may be utilized to develop an expected severity of occurrences of second parameter-related loss for the specific object (and/or account or other group of objects). In some embodiments, the second parameter loss severity distribution determined at 308b may be similar to a standard or typical loss frequency distribution utilized by an insurer to assess risk.

It should also be understood that the first parameter-based determinations 302a, 304a, 306a, 308a and second parameter-based determinations 302b, 304b, 306b, 308b are separately depicted in FIG. 3 for ease of illustration of one embodiment descriptive of how risk metrics may be included to enhance standard risk assessment procedures. According to some embodiments, the first parameter-based determinations 302a, 304a, 306a, 308a and second parameter-based determinations 302b, 304b, 306b, 308b may indeed be performed separately and/or distinctly in either time or space (e.g., they may be determined by different software and/or hardware modules or components and/or may be performed serially with respect to time). In some embodiments, the first parameter-based determinations 302a, 304a, 306a, 308a and second parameter-based determinations 302b, 304b, 306b, 308b may be incorporated into a single risk assessment process or “engine” that may, for example, comprise a risk assessment software program, package, and/or module. According to some embodiments either or both of the first parameter and second parameter may comprise a plurality of parameters, variables, and/or metrics.

In some embodiments, the method 300 may comprise determining a hazard grade or other type of risk score (e.g., for an object, account, and/or group of objects—e.g., objects related in a manner other than sharing an identical or similar class designation), at 310. According to some embodiments, formulas, charts, and/or tables may be developed that associate various first parameter and/or second parameter metric magnitudes with risk scores. Risk scores for a plurality of first parameter and/or second parameter metrics may be determined, calculated, tabulated, and/or summed to arrive at a total risk score for an object and/or account (e.g., a business, a property, a property feature, a portfolio and/or group of properties and/or objects subject to a particular risk) and/or for an object class. According to some embodiments, risk scores may be derived from the first parameter and/or second parameter loss frequency distributions and the first parameter and/or second parameter loss severity distribution determined at 306a-b and 308a-b, respectively. More details on one method for assessing risk are provided in commonly-assigned U.S. Pat. No. 7,330,820 entitled “PREMIUM EVALUATION SYSTEMS AND METHODS,” which issued on Feb. 12, 2008, the risk assessment concepts and descriptions of which are hereby incorporated by reference herein.

In some embodiments, the method 300 may also or alternatively comprise providing various recommendations, suggestions, guidelines, and/or rules directed to reducing and/or minimizing risk, premiums, etc. According to some embodiments, the results of the method 300 may be utilized to determine a premium for an insurance policy for, e.g., a specific business, object, and/or account analyzed. Any or all of the first parameter and/or second parameter loss frequency distributions of 306a-b, the first parameter and/or second parameter loss severity distributions of 308a-b, and the risk score of 310 may, for example, be passed to and/or otherwise utilized by a premium calculation process via the node labeled “A” in FIG. 3.

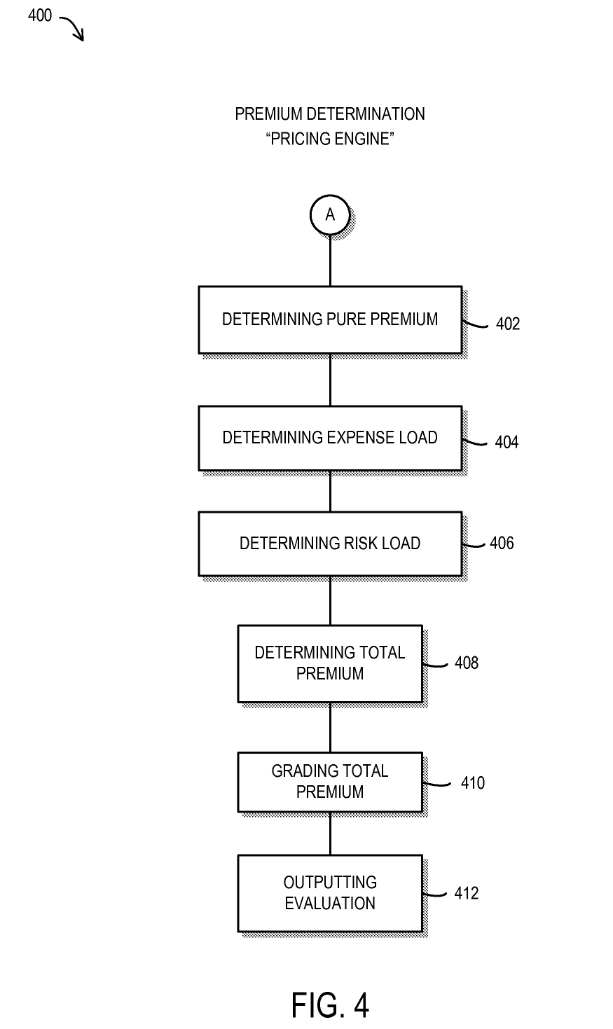

Turning to FIG. 4, for example, a flow diagram of a method 400 (that may initiate at the node labeled “A”) according to some embodiments is shown. In some embodiments, the method 400 may comprise a premium determination method which may, for example, be described as a “pricing engine”. According to some embodiments, the method 400 may be implemented, facilitated, and/or performed by or otherwise associated with the systems described herein. In some embodiments, the method 400 may be associated with the method 200 of FIG. 2. The method 400 may, for example, comprise a portion of the method 200 such as premium calculation 240. Any other technique for calculating an insurance premium that uses insurance information described herein may be utilized, in accordance with some embodiments, as deemed practicable and/or desirable.

In some embodiments, the method 400 may comprise determining a pure premium, at 402. A pure premium is a basic, unadjusted premium that is generally calculated based on loss frequency and severity distributions. According to some embodiments, the first parameter and/or second parameter loss frequency distributions (e.g., from 306a-b in FIG. 3) and the first parameter and/or second parameter loss severity distributions (e.g., from 308a-b in FIG. 3) may be utilized to calculate a pure premium that would be expected, mathematically, to result in no net gain or loss for the insurer when considering only the actual cost of the loss or losses under consideration and their associated loss adjustment expenses. Determination of the pure premium may generally comprise simulation testing and analysis that predicts (e.g., based on the supplied frequency and severity distributions) expected total losses (first parameter-based and/or second parameter-based) over time.

According to some embodiments, the method 400 may comprise determining an expense load, at 404. The pure premium determined at 402 does not take into account operational realities experienced by an insurer. The pure premium does not account, for example, for operational expenses such as overhead, staffing, taxes, fees, etc. Thus, in some embodiments, an expense load (or factor) is determined and utilized to take such costs into account when determining an appropriate premium to charge for an insurance product. According to some embodiments, the method 400 may comprise determining a risk load, at 406. The risk load is a factor designed to ensure that the insurer maintains a surplus amount large enough to produce an expected return for an insurance product.

According to some embodiments, the method 400 may comprise determining a total premium, at 408. The total premium may generally be determined and/or calculated by summing or totaling one or more of the pure premium, the expense load, and the risk load. In such a manner, for example, the pure premium is adjusted to compensate for real-world operating considerations that affect an insurer.

According to some embodiments, the method 400 may comprise grading the total premium, at 410. The total premium determined at 408, for example, may be ranked and/or scored by comparing the total premium to one or more benchmarks. In some embodiments, the comparison and/or grading may yield a qualitative measure of the total premium. The total premium may be graded, for example, on a scale of “A”, “B”, “C”, “D”, and “F”, in order of descending rank. The rating scheme may be simpler or more complex (e.g., similar to the qualitative bond and/or corporate credit rating schemes determined by various credit ratings agencies such as Standard & Poor's' (S&P) Financial service LLC, Moody's Investment Service, and/or Fitch Ratings from Fitch, Inc., all of New York, N.Y.) as deemed desirable and/or practicable. More details on one method for calculating and/or grading a premium are provided in commonly-assigned U.S. Pat. No. 7,330,820 entitled “PREMIUM EVALUATION SYSTEMS AND METHODS” which issued on Feb. 12, 2008, the premium calculation and grading concepts and descriptions of which are hereby incorporated by reference herein.

According to some embodiments, the method 400 may comprise outputting an evaluation, at 412. In the case that the results of the determination of the total premium at 408 are not directly and/or automatically utilized for implementation in association with an insurance product, for example, the grading of the premium at 410 and/or other data such as the risk score determined at 310 of FIG. 3 may be utilized to output an indication of the desirability and/or expected profitability of implementing the calculated premium. The outputting of the evaluation may be implemented in any form or manner practicable or desirable. One or more recommendations, graphical representations, visual aids, comparisons, and/or suggestions may be output, for example, to a device (e.g., a server and/or computer workstation) operated by an insurance underwriter and/or sales agent. One example of an evaluation comprises a creation and output of a risk matrix which may, for example, be developed utilizing Enterprise Risk Register® software, which facilitates compliance with ISO 17799/ISO 27000 requirements for risk mitigation and which is available from Northwest Controlling Corporation Ltd. (NOWECO) of London, UK.

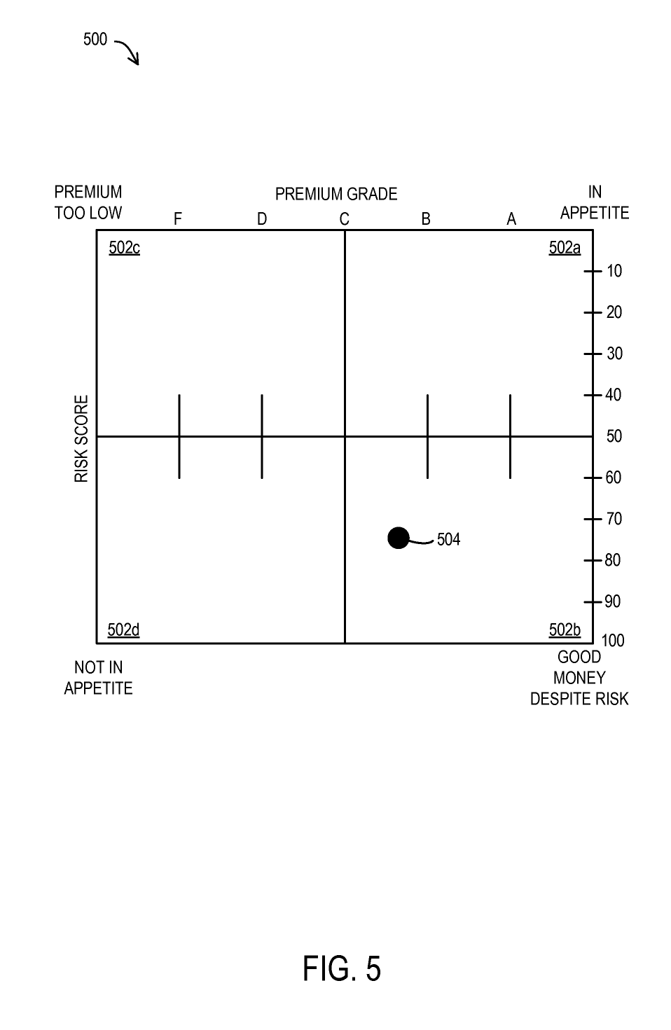

Referring to FIG. 5, for example, a diagram of an exemplary risk matrix 500 according to some embodiments is shown. In some embodiments (as depicted), the risk matrix 500 may comprise a simple two-dimensional graph having an X-axis and a Y-axis. Any other type of risk matrix, or no risk matrix, may be used if desired. The detail, complexity, and/or dimensionality of the risk matrix 500 may vary as desired and/or may be tied to a particular insurance product or offering. In some embodiments, the risk matrix 500 may be utilized to visually illustrate a relationship between the risk score (e.g., from 230 of FIG. 2 and/or from 310 of FIG. 3) of an object (and/or account and/or group of objects) and the total determined premium (e.g., from 240 of FIG. 2 and/or 408 of FIG. 4; and/or a grading thereof, such as from 410 of FIG. 4) for an insurance product offered in relation to the business and/or object (and/or account and/or group of objects). As shown in FIG. 5, for example, the premium grade may be plotted along the X-axis of the risk matrix 500 and/or the risk score may be plotted along the Y-axis of the risk matrix 500.

In such a manner, the risk matrix 500 may comprise four (4) quadrants 502a-d (e.g., similar to a “four-square” evaluation sheet utilized by automobile dealers to evaluate the propriety of various possible pricing “deals” for new automobiles). The first quadrant 502a represents the most desirable situations where risk scores are low and premiums are highly graded. The second quadrant 502b represents less desirable situations where, while premiums are highly graded, risk scores are higher. Generally, object-specific data that results in data points being plotted in either of the first two quadrants 502a-b is indicative of an object for which an insurance product may be offered on terms likely to be favorable to the insurer. The third quadrant 502c represents less desirable characteristics of having poorly graded premiums with low risk scores and the fourth quadrant 502d represents the least desirable characteristics of having poorly graded premiums as well as high risk scores. Generally, object-specific data that results in data points being plotted in either of the third and fourth quadrants 502c-d is indicative of an object for which an insurance product offering is not likely to be favorable to the insurer.

One example of how the risk matrix 500 may be output and/or implemented with respect to insurance data for an account and/or group of objects will now be described. Assume, for example, that a business insurance policy is desired by a client or consumer and/or that business insurance policy product is otherwise analyzed to determine whether such a policy would be beneficial for an insurer to issue. Typical risk metrics such as the gross receipts of the business and/or the business classification of the business may be utilized to produce expected loss frequency and loss severity distributions (such as determined at 306b and 308b of FIG. 3).

In some embodiments, first parameter metrics associated with the business, property, and/or account (i.e., the object(s) being insured), such as a geo-coded probability of wind damage, may also be utilized to produce expected wind damage loss frequency and loss severity distributions (such as determined at 306a and 308a of FIG. 3). According to some embodiments, singular loss frequency and loss severity distributions may be determined utilizing both typical risk metrics, as well as second parameter metrics (of the business/object being insured and/or of other associated objects, such as other properties belonging to the same account, sub-account, etc.).

In the case that the risk rating for the account is greater than a certain pre-determined magnitude (e.g., threshold), based on likelihood of loss due to operations in a particular business class for example, the risk score for the business and/or account may be determined to be relatively high, such as seventy-five (75) on a scale from zero (0) to one hundred (100), as compared to a score of fifty (50) for a second risk rating (e.g., a different business class). Other factors such as the loss history for the account/object(s) (and/or other factors) may also contribute to the risk score for the business, property, building/structure, consumer, account, and/or insurance product associated therewith.

The total premium calculated for a potential insurance policy offering covering the property/account/object(s) (e.g., determined at 408 of FIG. 4) may, to continue the example, be graded between “B” and “C” (e.g., at 410 of FIG. 4) or between “Fair” and “Average”. The resulting combination of risk score and premium rating may be plotted on the risk matrix 500, as represented by a data point 504 shown in FIG. 5. The data point 504, based on the risk score and the corresponding premium calculation, is plotted in the second quadrant 502b, in a position indicating that while the risk of insuring the business/property/account/object(s) is relatively high, the calculated premium is probably large enough to compensate for the level of risk. In some embodiments, an insurer may accordingly look favorably upon issuing such an insurance policy to the client to cover the business/property/account/object(s) in question and/or may consummate a sale of such a policy to the client/consumer (e.g., based on the evaluation output at 412 of FIG. 4, such a decision and/or sale may be made).

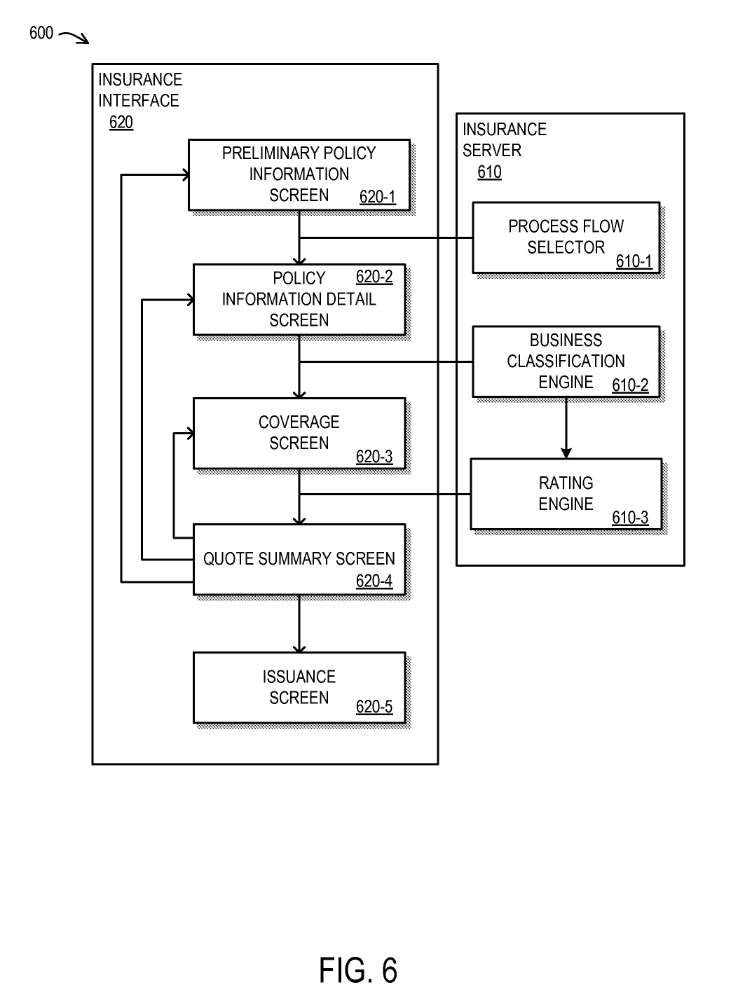

Referring now to FIG. 6, a block diagram of a system 600 according to some embodiments is shown. In some embodiments, the system 600 may comprise an insurance server 610 and/or an insurance interface 620. According to some embodiments, the insurance server 610 may comprise (e.g., be chronologically, programmatically, logically, physically, and/or functionally apportioned into) one or more of a process flow selector 610-1, a business classification engine 610-2, and/or a rating engine 620-3. In some embodiments, the insurance interface 620 may comprise (e.g., be chronologically, programmatically, logically, physically, and/or functionally apportioned into) one or more of a preliminary policy information screen 620-1, a policy information detail screen 620-2, a coverage screen 620-3, a quote summary screen 620-4, and/or an issuance screen 620-5.

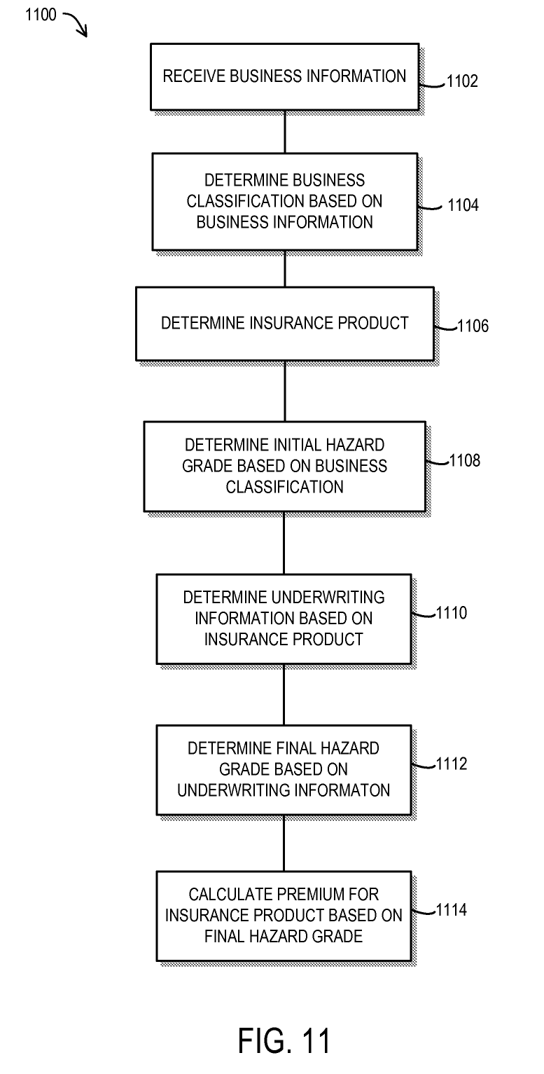

According to some embodiments, any or all of the components 610, 610-1, 610-2, 610-3, 620, 620-1, 620-2, 620-3, 620-4, 620-5 of the system 600 may be similar in configuration and/or functionality to any similarly named and/or numbered components described herein. Fewer or more components 610, 610-1, 610-2, 610-3, 620, 620-1, 620-2, 620-3, 620-4, 620-5 (and/or portions thereof) and/or various configurations of the components 610, 610-1, 610-2, 610-3, 620, 620-1, 620-2, 620-3, 620-4, 620-5 may be included in the system 600 without deviating from the scope of embodiments described herein. The system 600 may comprise a single device, a combination of devices and/or components 610, 610-1, 610-2, 610-3, 620, 620-1, 620-2, 620-3, 620-4, 620-5, and/or a plurality of devices, as is or becomes desirable and/or practicable. Similarly, in some embodiments, one or more of the various components 610, 610-1, 610-2, 610-3, 620, 620-1, 620-2, 620-3, 620-4, 620-5 may not be needed and/or desired in the system 600. In some embodiments, the system 600 may be configured and/or utilized to implement and/or facilitate any of the methods 200, 300, 400, 1000 of FIG. 2, FIG. 3, FIG. 4, and/or FIG. 11 herein, or one or more portions and/or combinations thereof.

In some embodiments, the preliminary policy information screen 620-1 (and/or the insurance interface 620) may be provided to a user (not shown) in connection with the operation of the insurance server 610. The insurance server 610 may generate the insurance interface 620, for example, and/or may define and/or cause a generation of the insurance interface 620. The insurance interface 620 may, for example, be driven and/or generated by instructions and/or data sent from the insurance server 610 to one or more other devices (not shown in FIG. 6; such as one or more of the user devices 102a-n of FIG. 1). In some embodiments, the insurance interface 620 may be output by an application (not explicitly depicted in FIG. 6) that receives instructions and/or data from the insurance server 610.

According to some embodiments, the preliminary policy information screen 620-1 may comprise one or more data fields, forms, and/or input areas labeled and/or otherwise configured for entry of initial, basic, background, and/or preliminary policy information. Such information may comprise, for example, an indication of a desired policy effective date, an indication of a current date, an indication of a state or other jurisdiction in which the policy is desired, an indication of a policy type desired, etc. In some embodiments, preliminary policy information entered (e.g., by a user and/or via a user device not shown in FIG. 6) into and/or received by the preliminary policy information screen 620-1 (e.g., by the insurance interface 620) may be utilized by the process flow selector 610-1 of the insurance server 610. The process flow selector 610-1 may, for example, comprise a set of rules and/or logical programming steps that are configured to accept as inputs data from the preliminary policy information screen 620-1. According to some embodiments, the output of the process flow selector 610-1 may comprise an indication of an appropriate interface and/or rule set flow based on the preliminary information received via the preliminary policy information screen 620-1. The process flow selector 610-1 may, for example, trigger, define, and/or cause the output and/or generation of the policy information detail screen 620-2.

A user of the insurance interface 620 may, for example, select a button or command (not shown in FIG. 6) that triggers a call to the process flow selector 610-1 and/or causes an outputting of the policy information detail screen 620-2. The policy information detail screen 620-2 may, in some embodiments, comprise one or more data fields, forms, and/or input areas labeled and/or otherwise configured for entry of more detailed and/or additional policy information. Such information may comprise, for example, an indication of characteristics and/or attributes of a business to be insured (e.g., gross receipts, payroll, square footage of business operations, business location(s), etc.), geospatial data, third-party data descriptive of a business and/or location, etc. According to some embodiments, the policy information detail screen 620-2 may comprise and/or provide a plurality of business classification questions and/or underwriting questions (e.g., for which, answers may be received by the insurance server 610 via the policy information detail screen 620-2). In some embodiments, detailed policy information entered (e.g., by the user and/or via the user device) into and/or received by the policy information detail screen 620-2 (e.g., by the insurance interface 620) may be utilized by the business classification engine 610-2 of the insurance server 610. The business classification engine 610-2 may, for example, comprise a set of rules and/or logical programming steps that are configured to accept as inputs data from the policy information detail screen 620-2. According to some embodiments, the output of the business classification engine 610-2 may comprise an indication of a preliminary business classification, possible and/or applicable business classifications, business reclassification information, and/or business classification/reclassification tiebreaking information, any or all of which may be based (at least in part) on the detailed policy information received via the policy information detail screen 620-2. According to some embodiments, the business classification engine 610-2 may trigger, define, and/or cause the output and/or generation of the coverage screen 620-3 and/or may provide input to the rating engine 610-3.

In some embodiments for example, a user of the insurance interface 620 may select a button or command (not shown in FIG. 6) that triggers a call to the business classification engine 610-2 and/or causes an outputting of the coverage screen 620-3. The coverage screen 620-3 may, in some embodiments, comprise one or more data fields, forms, and/or input areas labeled and/or otherwise configured for entry and/or verification of data descriptive of one or more types, levels, and/or characteristics of insurance (and/or other underwriting) coverage that is desired.

According to some embodiments, coverage information entered (e.g., by the user and/or via the user device) into and/or received by the coverage screen 620-3 (e.g., by the insurance interface 620) may be utilized by the rating engine 610-3 of the insurance server 610. The rating engine 610-3 may, for example, comprise a set of rules and/or logical programming steps that are configured to accept as inputs data from the coverage screen 620-3 and/or data from the business classification engine 610-2.

According to some embodiments, the output of the rating engine 610-3 may comprise an indication of one or more of a risk rating (e.g., a hazard grade) and policy pricing information (e.g., premiums, deductibles, discounts, surcharges, fees), which may be based (at least in part) on the coverage information received via the coverage screen 620-3 and/or the business classification/reclassification information (e.g., a final business classification resulting from a business classification tiebreaking selection processes) received from the business classification engine 610-2. According to some embodiments, the rating engine 610-3 may trigger, define, and/or cause the output and/or generation of the quote summary screen 620-4.

A user of the insurance interface 620 may, for example, select a button or command (not shown in FIG. 6) that triggers a call to the rating engine 610-3 and/or causes an outputting of the quote summary screen 620-4. The quote summary screen 620-4 may, in some embodiments, comprise data descriptive of one or more of a risk rating, policy pricing, coverage, limits, and/or other policy details descriptive of an insurance and/or other underwriting product offered to the user (e.g., agent, customer, client, potential customer, etc.) based on the information received from the user via the insurance interface 620 (and/or based on other information such as third-party and/or pre-stored data). In some embodiments, the quote summary screen 620-4 may comprise links and/or paths via which the user may proceed back to any or all of the preliminary policy information screen 620-1, the policy information detail screen 620-2, and/or the coverage screen 620-3 to verify, change, update, and/or otherwise edit and/or review data upon which an insurance product quotation provided by the quote summary screen 620-4 is based. In such a manner, for example, the user may iteratively provide data via the insurance interface 620 and receive in response thereto (e.g., via the quote summary screen 620-4) an indication of a quote for an underwriting product such as a business insurance policy.

According to some embodiments, once the user is satisfied with the provided quote, product offering, and/or provided data, the user may select a button or command (not shown in FIG. 6) that triggers and/or causes an outputting of the issuance screen 620-5. The issuance screen 620-5 may, for example, provide finalized information regarding payment and/or execution of necessary documents and/or forms required for consummating an instance of the desired insurance product.

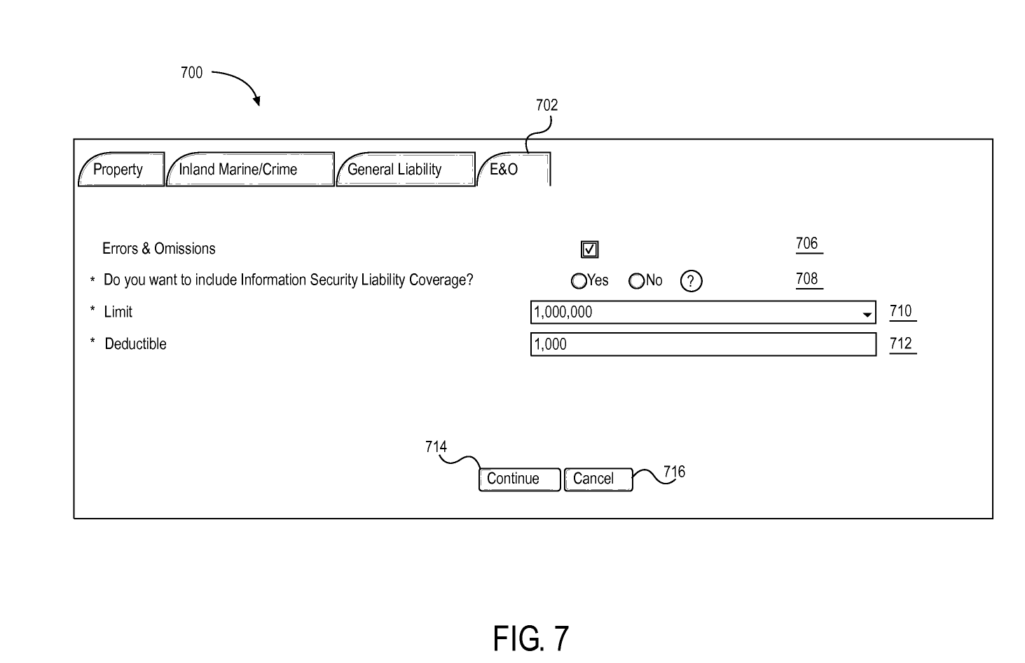

Turning now to FIG. 7, a diagram of an example interface 700 according to some embodiments is shown. In some embodiments, the interface 700 may comprise a web page, web form, database entry form, Application Programming Interface (API), spreadsheet, table, and/or application or other Graphical User Interface (GUI) via which an agent/broker (or customer or other entity) may enter data to conduct and/or facilitate an insurance product rating, underwriting, and/or sales process. The interface 700 may, for example, comprise a front end of an underwriting program and/or platform programmed and/or otherwise configured to execute, conduct, and/or facilitate any of the various methods described herein, and/or portions or combinations thereof. In some embodiments, the interface 700 may be output via a computerized device such as one or more of the user devices 102a-n and/or the controller device 110 or the insurance server 610, of FIG. 1 and/or FIG. 6 herein. In some embodiments, the interface 700 may comprise an exemplary instance of the coverage screen 620-3 of the insurance interface 620 of FIG. 6 herein.

According to some embodiments, the interface 700 may comprise one or more tabs and/or other segmented and/or logically-presented data forms and/or fields. In some embodiments, the interface 700 may be configured and/or organized to allow and/or facilitate entry of detailed and/or specific information regarding a business, policy, customer account (and/or potential customer account). As depicted, for example, the interface 700 may provide one or more tabs associated with respective types of coverage and/or insurance products (e.g., E&O coverage tab 702).

According to some embodiments, one or more areas (e.g., one or more data entry mechanisms, tools, objects, and/or features) may be provided that provide for entry/editing of policy data descriptive of a business, an account, policy, and/or product. As depicted for exemplary purposes in FIG. 7, the interface 700 may comprise one or more form objects 706, 708 by which a user (e.g., an agent/broker) may select one or more types of policy coverage and/or insurance product options (e.g., “Errors & Omissions” coverage, “Information Security Liability Coverage”) for risk assessment (e.g., hazard grade determination) and/or premium calculation. As depicted in interface 700, policy data may comprise data defining a coverage limit 710 (e.g., $1,000,000) and/or a coverage deductible amount 712. (e.g., $1,000). According to some embodiments, determinations as to a customer's eligibility for a particular insurance product may be based at least in part on policy data (e.g., an indicated coverage limit and/or deductible amount).

According to some embodiments, the interface 700 may include a continue button 714 and/or a cancel button 716. In one example, actuating the continue button 714 may initiate a process for determining whether a customer is eligible for a particular insurance product and/or may trigger an underwriting routine (e.g., presenting underwriting questions to a user and/or evaluating responses to underwriting questions) associated with a particular coverage option (e.g., E&O coverage). Alternatively, or in addition, according to some embodiments, upon receipt of input from a user (e.g., selection of the Errors & Omissions checkbox 706; input of a qualifying policy limit 710) the interface 700 may initiate a process for determining whether a customer is eligible for a particular insurance product and/or may trigger an underwriting routine.

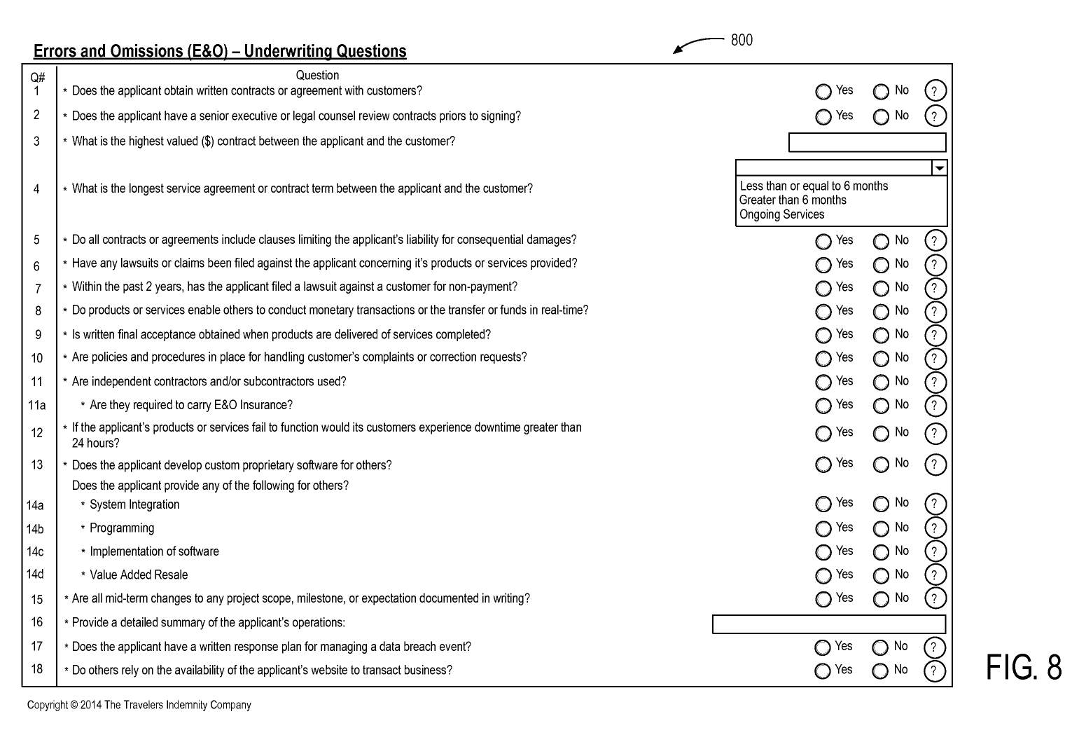

Turning now to FIG. 8, a diagram of an example interface 800 according to some embodiments is shown. In some embodiments, the interface 800 may comprise a web page, web form, database entry form, Application Programming Interface (API), spreadsheet, table, and/or application or other Graphical User Interface (GUI) via which an agent/broker (or customer or other entity) may enter data to conduct and/or facilitate an insurance product rating, underwriting, and/or sales process. The interface 800 may, for example, comprise a front end of an underwriting program and/or platform programmed and/or otherwise configured to execute, conduct, and/or facilitate any of the various methods described herein, and/or portions or combinations thereof. In some embodiments, the interface 800 may be output via a computerized device such as one or more of the user devices 102a-n and/or the controller device 110 or the insurance server 610, of FIG. 1 and/or FIG. 6 herein. In some embodiments, the interface 800 may comprise an exemplary instance of the coverage screen 620-3 of the insurance interface 620 of FIG. 6 herein. In some embodiments, the interface 800 may be presented in response to a determination that a customer is eligible for a particular coverage and/or in response to a user triggering an underwriting routine (e.g., by actuating the example continue button 714 of interface 700 in FIG. 7).

According to some embodiments, the interface 800 may comprise one or more tabs and/or other segmented and/or logically-presented data forms and/or fields. In some embodiments, the interface 800 may be configured and/or organized to allow and/or facilitate entry of detailed and/or specific information with respect to one or more types of insurance coverage.

According to some embodiments, as depicted in FIG. 8, the interface 800 may comprise one or more underwriting questions associated with one or more coverage options. As depicted in FIG. 8, for example, the interface 800 may provide one or more questions associated with E&O coverage, and respective interface objects for receiving input from a user (e.g., an agent/broker) in response to the E&O questions (e.g., as part of an underwriting and/or risk assessment process). The underwriting questions, in some embodiments, may comprise any type, quantity, and/or configuration of data fields and/or interface objects regarding business and/or underwriting questions, rules, parameters, and/or guidelines. The underwriting questions may, as depicted for example, comprise information descriptive of questions configured to obtain information directed to the business of the customer. In some embodiments, underwriting questions may be directed to determining eligibility for a particular coverage and/or determining information relevant to risk assessment (e.g., for determining a hazard grade).

While various components of the example interfaces 700 and 800 have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

Turning now to FIG. 9, an example underwriting question data table 900 according to some embodiments is shown. In some embodiments, the underwriting question data table 900 may be utilized (e.g., in accordance with the method 1100 of FIG. 11 herein) to store, determine, and/or utilize business and/or insurance policy (e.g., customer) data (e.g., provided by a user device 102a-n of FIG. 1), such as to determine an appropriate hazard grade or other risk assessment without requiring the participation of an insurance underwriter (e.g., for business insurance accounts meeting one or more eligibility criteria).

The underwriting question data table 900 may comprise, in accordance with some embodiments, an underwriting question identifier (ID) field 902, an underwriting question field (not shown) describing a question associated with a respective question identifier, a hazard grade modification rule(s) field 904, and/or a hazard grade category field 906. Any or all of the category and/or ID fields described herein may generally store any type of identifier deemed desirable or practicable (e.g., a unique identifier, an alphanumeric identifier, and/or an encoded identifier).

According to some embodiments, the underwriting question data table 900 may generally store data that relates underwriting questions and/or answers to one or more rules for evaluating and/or modifying a hazard grade associated with a business, coverage, and/or insurance product. In such a manner, for example, answers to such questions may be utilized to identify appropriate risk assessments for a particular question (e.g., an HG question score), a particular hazard grade category (e.g., an HG category score), and/or an account (e.g., an account-level hazard grade and/or an account-level HG score).

In some embodiments, each underwriting question ID field 902 may be associated with a field in the same or a different data table (not shown) for a particular underwriting question (e.g., an E&O underwriting question). For example, the underwriting question field may store data indicative of a particular underwriting question, query, and/or informational statement (e.g., the text of a question for output via a user interface). Such questions, some examples of which are provided in interface 800 of FIG. 8 with respect to an example E&O underwriting questionnaire, may be provided to and/or asked of a user (e.g., presented to an agent/broker via an insurance interface), for example, to solicit information that facilitates hazard grade determination (e.g., an appropriate modification to an initial hazard grade based on business classification).

According to some embodiments, the hazard grade modification rule(s) field 904 may store information indicative of one or more criteria, conditions, and/or rules defining whether and/or how a particular answer to the associated underwriting question may affect hazard grade determination.

As depicted for exemplary purposes only, for example, if the answer provided by a user to the first underwriting question identified as “UW-HG-EO-107” is “NO”, then the hazard grade is increased to the next highest hazard grade in the hazard grade ranking system. For instance, according to the example hazard grade modification rule, if the initial hazard grade for an account is “Medium”, then an answer of “No” to question “UW-HG-EO-107” will increase the hazard grade from “Medium” to the next highest hazard grade (e.g., “Medium High”). In another example, an answer of “No” to question “UW-HG-EO-109” will increase the associated hazard grade, and an answer of “Yes” will decrease the associated hazard grade. In another example, an answer of “C” to question “UW-HG-EO-115” will increase the associated hazard grade, while any other answer to that question will result in maintaining an initial hazard grade (e.g., based on business classification). Accordingly, a modification rule may describe circumstances in which no modification is made to an initial hazard grade. Various examples of hazard grade determinations for questions, categories, and accounts based on underwriting questions, answers, and modification rules are discussed in more detail with respect to example HG determination data table 1000 of FIG. 10 and method 1100 of FIG. 11.

According to some embodiments, the hazard grade category field 906 may store information indicative of a category or type of risk concern (e.g., product complexity, business management, financial strength, business longevity, prior loss history, susceptibility of product to defect) associated with a respective question. According to some embodiments, as described with respect to example HG determination data table 1000 of FIG. 10 and method 1100 of FIG. 11, hazard grade determination may comprise determining a respective hazard grade score for each of a plurality of different hazard grade categories, and then determining an overall hazard grade (e.g., an account-level hazard grade) based on the plurality of hazard grade category scores (e.g., in accordance with a formula and/or one or more respective category weighting factors).

Turning now to FIG. 10, an example HG determination data table 1000 according to some embodiments is shown. In some embodiments, the HG determination data table 1000 may be utilized (e.g., in accordance with the method 1100 of FIG. 11 herein) to store, determine, and/or utilize hazard grade data to determine an appropriate hazard grade or other risk assessment for an insurance customer, without requiring the participation of an insurance underwriter. The example information depicted in the example HG determination data table 1000 is representative of an example evaluation of risk for an insurance account (e.g., in accordance with one or more methods described in this disclosure) based on the example questions and rules of underwriting question data table 900.

The HG determination data table 1000 may comprise, in accordance with some embodiments, an indication of initial hazard grade 1004 for an account (e.g., “High”). As described in this disclosure, an initial hazard grade may be based on a business classification for an account. The initial hazard grade 1004 may be utilized, in accordance with various embodiments, in determining one or more final hazard grades and/or final hazard grade scores (e.g., based on one or more hazard grade modification rules).

The HG determination data table 1000 may comprise, in accordance with some embodiments, an underwriting question identifier (ID) field 1006, an answer field 1008, a final hazard grade field 1010, and/or a final hazard grade (HG) score field 1012. According to some embodiments, HG determination data table 1000 may generally store data that relates particular underwriting questions and/or answers to corresponding hazard grades (e.g., hazard grade levels and/or hazard grade scores) for evaluating and/or modifying a hazard grade associated with a business, coverage, and/or insurance product. As discussed with respect to underwriting question data table 900, answers to one or more underwriting questions may be utilized, in accordance with some embodiments, to evaluate appropriate risk assessments based on one or more questions, one or more hazard grade categories, and/or an account (e.g., based on one or more hazard grade question scores and/or hazard grade category scores).

As depicted for exemplary purposes only, answer field 1008 includes example answers provided by a user (e.g., received from an agent/broker via a user interface) to example underwriting questions identified in underwriting question ID 1006. In accordance with one or more embodiments, each question is also associated with a respective final hazard grade 1010 and/or a final HG score 1012. In one or more embodiments, the final hazard grade 1010 and/or the final HG score 1012 may be determined in accordance with one or more modification rules (e.g., hazard grade modification rules 904 stored in underwriting question data table 902) to: (i) determine a final hazard grade based on a rule, the initial hazard grade, an initial hazard grade score, and/or a final HG score; and/or (ii) determine a final HG score based on a rule, the initial hazard grade, an initial hazard grade score, and/or the final hazard grade. Although both a hazard grade and a hazard grade score are included for exemplary purposes in example HG determination data table 1000, it will be readily understood that one or both of the risk assessment metrics may be utilized as deemed practicable and/or desirable for a particular implementation.

According to some embodiments, a hazard grade system may include a plurality of different hazard grades (e.g., “High”, “Medium”, “Low”), with each hazard grade being associated with a particular hazard grade score (e.g., a default hazard grade score associated with a particular grade) and/or with a particular hazard grade score range (e.g., “Low” may correspond to a hazard score range of 0.0 to 14.9). The following table depicts, without limitation and for purposes of illustration only, an example configuration of a hazard grade ranking system:

| Hazard Grade | Hazard Grade | Hazard Grade |
|---|---|---|
| Description | Score Range | Default Score |
| Low | 37-43 | 40 |
| Low Medium | 30-36 | 33 |
| Medium | 23-29 | 26 |
| Medium High | 16-22 | 19 |
| High | 9-15 | 12 |
| Very High | 1-8 | 5 |

Referring again to the example HG determination data table 1000, the answer of “Yes” to the underwriting question “UW-HG-EO-107” corresponds to a final hazard grade of “High” for that question. For instance, applying the example hazard modification rule of underwriting question data table 900 to the “Yes” answer for that question results in no change to the hazard grade for that question—the final hazard grade of “High” is the same as the example initial grade of “High”. According to the example HG determination based on question “UW-HG-EO-107” and utilizing the example hazard grade ranking system above, the hazard grade of “High” is associated with an HG score of 12. In another example, the answer of “Yes” to the underwriting question “UW-HG-EO-109” corresponds to a final hazard grade of “Medium High” for that question. For instance, applying the example hazard modification rule of underwriting question data table 900 to the “Yes” answer for that question results in a hazard grade that is one step or rank lower than the initial hazard grade—the final hazard grade of “Medium High” is the next lower hazard grade from the initial grade of “High”. According to the example HG determination based on question “UW-HG-EO-109” and utilizing the example hazard grade ranking system above, the hazard grade of “Medium High” may be associated with an HG score of 19.

According to some embodiments, a hazard grade determination process may comprise determining a final hazard grade based on one or more question hazard grades. For example, determining a final hazard grade for an account may comprise averaging all of the respective final HG scores for a plurality of questions, and determining a corresponding final hazard grade for the account (e.g., by determining which hazard grade score range the average final HG score falls into). In one example, the average final HG score for the five questions depicted in HG determination data table 1000, based on the example final HG question scores, would be 21.8, which corresponds to the “Medium High” hazard grade in the example hazard grade ranking system above. As discussed with respect to various embodiments in this disclosure, the final hazard grade may be used in a premium calculation process to calculate premium for a particular insurance product. For example, a final hazard grade of “Medium High” may correspond to a particular base rate for input in a premium calculation formula.

According to some embodiments, a hazard grade determination process may comprise determining a final hazard grade for each of two or more hazard grade categories. For example, as discussed above with respect to underwriting question data table 900, each underwriting question may be associated with one or more hazard grade categories. Accordingly, a hazard grade and/or a hazard grade score may be determined for a given hazard grade category, such as by averaging the scores for the questions in that category. According to some embodiments, an account-level hazard grade may then be determined based on two or more hazard grade category scores and respective weights (e.g., a multiplier) associated with each category.

In one embodiment, a hazard grade formula for evaluating a hazard grade for an account based on category scores and respective category multipliers may be expressed as:

HG_Account=(HG_Category_{—}1*Weight_Category_{—}1)+(HG_Category_{—}2*Weight_Category_{—}2)+ . . . +(HG_Category_{—}n*Weight_Category_{—}n)

where HG_Account is the account-level final HG score, HG_Category_{—}1 is the final HG score for a first hazard grade category, Weight_Category_{—}1 is a weight multiplier corresponding to HG_Category_{—}1, and so on for as many categories are desired for a given implementation. In one example, if the weight for a hazard grade category of “Product Complexity” with an HG score of 20.75 is 0.45, and the weight for a hazard grade category of “Management Control” with an HG score of 14.8 is 0.55, then the account-level final HG score, based on the example formula above, would be 17.48=9.34+8.14, which would correspond to a final hazard grade for the account of “Medium High” according to the example hazard grade ranking system discussed above.

A hazard grade for an insurance product may be based on one or more question-specific hazard grades and/or hazard grade scores. For example, determining a final hazard grade for an account may comprise averaging all of the respective final HG scores for a plurality of questions, and determining a corresponding final hazard grade for the account (e.g., by determining which hazard grade score range the average final HG score falls into). In one example, the average final HG score for the five questions depicted in HG determination data table 1000, based on the example final HG question scores, would be 21.8, which corresponds to the “Medium High” hazard grade in the example hazard grade ranking system above.

Turning now to FIG. 11, a flow diagram of a method 1100 according to some embodiments is shown. In some embodiments, the method 1100 may be implemented, facilitated, and/or performed by or otherwise associated with the systems 110, 600 of FIG. 1 and/or FIG. 6 herein (and/or portions thereof, such as the controller device 110). In some embodiments, the method 1100 may be associated with the methods 200, 300, 400 of FIG. 2, FIG. 3, and/or FIG. 4. The method 1100 may, for example, comprise one or more portions of the method 200 such as the insurance data processing 210, the insurance underwriting 220 (and/or the risk assessment 230 and/or premium calculation 240 thereof), and/or the insurance policy quote and issuance 250. In some embodiments, the method 1100 may be illustrative of automatic hazard grade determination and/or under underwriting processes as described herein.

According to some embodiments, the method 1100 may comprise receiving (e.g., by a processing device, from a user device, and/or via an electronic communications network) business information, at 1102. An insurance agent, broker, and/or insurance provider or underwriter server and/or other electronic device may, for example, receive one or more signals indicative of data descriptive of a particular business. Insurance data 202a-n of FIG. 2 may, in some embodiments, be received via the policy information detail screen 620-2. According to some embodiments, the business information may comprise business location information (e.g., address, coordinates), business identification information (e.g., a business or tax ID, business name, trademark), and/or business attribute and/or characteristic information (e.g., sales, revenue, profit, market capitalization, debt, workplace square footage, workforce data).

In some embodiments, the method 1100 may comprise determining (e.g., by the processing device) a business classification based on the business information, at 1104. The business information received at 1102 may, for example, be utilized to conduct one or more queries to third-party databases and/or information services, such as to conduct a “smart classification”, as described in co-pending U.S. patent application Ser. No. 13/179,464 filed on Jul. 8, 2011 and titled “SYSTEMS AND METHODS FOR BUSINESS CLASSIFICATION”, the business classification concepts and descriptions of which are already incorporated by reference herein. In some embodiments, the business classification may comprise a selection and/or determination of a business class applicable to a particular business, such as based on business location data. According to some embodiments, the business classification (e.g., determined automatically and/or without business classification input from a user/customer) may be provided and/or output to a user. In some embodiments, such as in the case that the automatic or “smart” classification results in a plurality of possible and/or applicable or appropriate business classes, the method 1100 may proceed to perform a tiebreaking process.

According to some embodiments, the method 1100 may comprise determining (e.g., by the processing device) an insurance product, at 1106. Based on the business information received at 1102, for example, a software program and/or computerized processing device may look up, search, identify, calculate, and/or otherwise determine one or more available policy types. According to some embodiments, the customer and/or underwriter may choose, select, and/or identify one or more desired policy types (e.g., E&O coverage). An interface may be utilized, for example, to select a desired policy type from a drop-down menu of available underwriting products. Such a menu of available product and/or policy types may, in some embodiments, be populated based on the determination of the business classification at 1104. In some embodiments, policy type selection may comprise a walk-through or “wizard” including questions configured and/or selected to assist an agent/broker and/or a customer in selecting an appropriate policy type based on the business classification, desired coverage, benefits, results, etc. In some embodiments, a computerized processing device such as a PC or computer server and/or a software program and/or interface may receive the policy type selection and/or one or more indications thereof (e.g., for use in policy pricing and/or sales, as described herein).

According to some embodiments for example, the method 1100 may comprise determining (e.g., by the processing device and/or via the electronic communications network) an initial hazard grade based on the business classification, at 1108. Each business classification may be associated (e.g., in a data table stored by and/or accessible by controller device 110, third-party device 106, and/or insurance server 610), for example, with a corresponding hazard grade. In some embodiments, determining an initial hazard grade may comprise determining the initial hazard grade based on the business classification and an indication of an insurance product (e.g., the insurance product determined at 1106). For example, different hazard grade ranking systems may be utilized for different types of insurance policies. The initial hazard grade for the business classification may, for example, be provided and/or output to the user.

According to some embodiments, the method 1100 may comprise determining (e.g., by the processing device) underwriting information based on the insurance product, at 1110. Underwriting questions such as those represented in example interface 800 of FIG. 8 and/or as stored in an underwriting questions data table may, for example, be provided and/or output to the user based on one or more types of coverage identified for an insurance product (e.g., selected by a user via interface 700 of FIG. 7). In one example, a user's selection of an E&O policy option may result in the output to the user of one or more underwriting questions related to an E&O insurance product (e.g., as depicted in interface 800). According to some embodiments, such questions may be based, alternatively or in addition, on the business classification determined at 1104. The underwriting questions may, for example, be selected, generated, and/or worded to elicit responses that are likely to be beneficial in determining an appropriate risk assessment for the desired insurance product. In some embodiments, determining underwriting information in the method 1100 may comprise receiving (e.g., by the processing device, from the user device) answers to underwriting questions. Answers to the questions provided and/or output may be received via an interface such as via the example interface 800 of FIG. 8. In some embodiments, determining underwriting information may comprise accessing information (e.g., answers to underwriting questions, and/or HG question scores) stored in a data table such as the example HG determination data table 1000 of FIG. 10. In some embodiments, determining the underwriting information may be based on input from a remote agent/broker, without requiring the participation or input of a human underwriter.

According to some embodiments, the method 1100 may comprise determining (e.g., by the processing device) a final hazard grade (e.g., for an insurance account) based on the underwriting information, at 1112. Various examples of determining hazard grades are described in this disclosure (e.g., with respect to example HG determination data table 1000). In one or more embodiments, determining the final hazard grade may comprise one or more of the following: determining the initial hazard grade (e.g., accessing an indication of the hazard grade determined at 1104), determining answers to underwriting questions, determining hazard modification rules associated with one or more questions, determining a hazard grade for one or more underwriting questions (e.g., based on an answer and rule for a given question), determining a hazard grade and/or hazard grade score for one or more questions, determining a hazard grade and/or hazard grade score for one or more hazard grade categories, determining a respective weight for each of a plurality of hazard grade categories, and/or determining an account-level final hazard grade and/or hazard grade score. In one embodiment, the final hazard grade based on the underwriting information may be the same as or may be different than an initial hazard grade. In some embodiments, the final hazard grade may be determined automatically, in response to input from a remote agent/broker, without requiring the participation of a human underwriter.

According to some embodiments, the method 1100 may comprise calculating (e.g., by the processing device) a premium for an insurance product based on the final hazard grade, at 1114. As discussed in this disclosure, a hazard grade may correspond to a particular base rate (e.g., stored in a data table) for use in calculating premium for an insurance product, in accordance with a premium calculation formula.

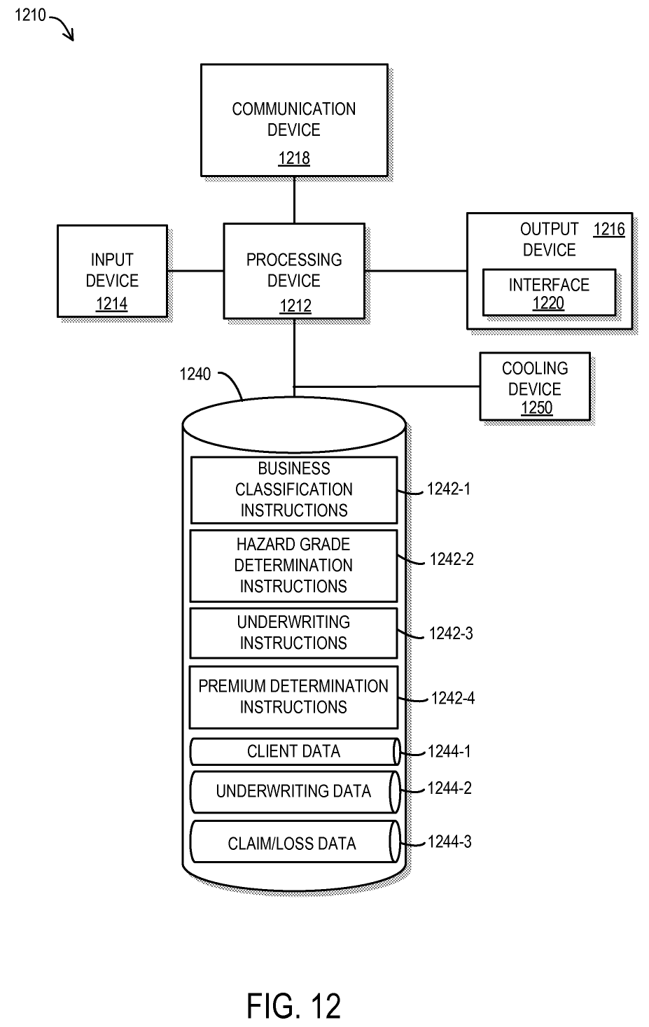

Turning to FIG. 12, a block diagram of an apparatus 1210 according to some embodiments is shown. In some embodiments, the apparatus 1210 may be similar in configuration and/or functionality to any of the controller device 110, the user devices 102a-n, and/or the third-party device 106, all of FIG. 1 herein, and/or the insurance server 610 of FIG. 6 herein. The apparatus 1210 may, for example, execute, process, facilitate, and/or otherwise be associated with the methods 200, 300, 400, 1100 of FIG. 2, FIG. 3, FIG. 4, and/or FIG. 11 herein, and/or portions or combinations thereof. In some embodiments, the apparatus 1210 may comprise a processing device 1212, an input device 1214, an output device 1216, a communication device 1218, an interface 1220, a memory device 1240 (storing various programs and/or instructions 1242 and data 1244), and/or a cooling device 1250. According to some embodiments, any or all of the components 1212, 1214, 1216, 1218, 1220, 1240, 1242, 1244, 1250 of the apparatus 1210 may be similar in configuration and/or functionality to any similarly named and/or numbered components described herein. Fewer or more components 1212, 1214, 1216, 1218, 1220, 1240, 1242, 1244, 1250 and/or various configurations of the components 1212, 1214, 1216, 1218, 1220, 1240, 1242, 1244, 1250 be included in the apparatus 1210 without deviating from the scope of embodiments described herein.

According to some embodiments, the processor 1212 may be or include any type, quantity, and/or configuration of processor that is or becomes known. The processor 1212 may comprise, for example, an Intel® IXP 2800 network processor or an Intel® XEON™ Processor coupled with an Intel® E7501 chipset. In some embodiments, the processor 1212 may comprise multiple inter-connected processors, microprocessors, and/or micro-engines. According to some embodiments, the processor 1212 (and/or the apparatus 1210 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 1210 comprises a server such as a blade server, necessary power may be supplied via a standard AC outlet, power strip, surge protector, and/or Uninterruptible Power Supply (UPS) device.

In some embodiments, the input device 1214 and/or the output device 1216 are communicatively coupled to the processor 1212 (e.g., via wired and/or wireless connections and/or pathways) and they may generally comprise any types or configurations of input and output components and/or devices that are or become known, respectively. The input device 1214 may comprise, for example, a keyboard that allows an operator of the apparatus 1210 to interface with the apparatus 1210 (e.g., by a consumer and/or agent, such as to price and/or purchase (or sell) insurance policies priced based on a hazard grade determination as described herein; and/or by an insurance agent, such as to evaluate risk and/or calculate premiums for an insurance policy based on a hazard grade determination as described herein). In some embodiments, the input device 1214 may comprise a sensor configured to provide information such as encoded location, business identification, and/or risk data to the apparatus 1210 and/or the processor 1212. The output device 1216 may, according to some embodiments, comprise a display screen and/or other practicable output component and/or device. The output device 1216 may, for example, provide an interface (such as one or more of the interfaces described herein) via which insurance pricing and/or risk analysis are provided to a potential client and/or to a sales agent attempting to structure an insurance product (e.g., via a computer workstation and/or website). According to some embodiments, the input device 1214 and/or the output device 1216 may comprise and/or be embodied in a single device such as a touch-screen monitor.

In some embodiments, the communication device 1218 may comprise any type or configuration of communication device that is or becomes known or practicable. The communication device 1218 may, for example, comprise a Network Interface Card (NIC), a telephonic device, a cellular network device, a router, a hub, a modem, and/or a communications port or cable. In some embodiments, the communication device 918 may be coupled to provide data to a client device, such as in the case that the apparatus 1210 is utilized to price and/or sell insurance products (e.g., based at least in part on a hazard grade modification and/or final hazard grade determination described herein). The communication device 1218 may, for example, comprise a cellular telephone network transmission device that sends signals indicative of risk rating and/or premium pricing information to a remote device (e.g., to a user device). According to some embodiments, the communication device 1218 may also or alternatively be coupled to the processor 1212. In some embodiments, the communication device 1218 may comprise an IR, RF, Bluetooth™, Near-Field Communication (NFC), and/or Wi-Fi® network device coupled to facilitate communications between the processor 1212 and another device (such as a client device and/or a third-party device, not shown in FIG. 12).

The memory device 1240 may comprise any appropriate information storage device including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1240 may, according to some embodiments, store one or more of business classification instructions 1242-1, risk assessment instructions 1242-2, underwriting instructions 1242-3, premium determination instructions 1242-4, client data 1244-1, underwriting data 1244-2, and/or claim/loss data 1244-3. In some embodiments, the instructions may be utilized by the processor 1212 to provide output information via the output device 1216 and/or the communication device 1218.

According to some embodiments, the business classification instructions 1242-1 may be operable to cause the processor 1212 to process the client data 1244-1, business information data, underwriting data 1244-2, and/or claim/loss data 1244-3 in accordance with embodiments as described herein. Information received via the input device 1214 and/or the communication device 1218 may, for example, be analyzed, sorted, filtered, decoded, decompressed, ranked, scored, plotted, and/or otherwise processed by the processor 1212 in accordance with business classification instructions 1242-1. In some embodiments, data may be fed by the processor 1212 through one or more mathematical and/or statistical formulas and/or models in accordance with the business classification instructions 1242-1 to identify a plurality of possible business classifications and/or reclassifications and/or select a final business classification or reclassification based on business classification tiebreaking, as described herein.

In some embodiments, the hazard grade determination instructions 1242-2 may be operable to cause the processor 1212 to process the client data 1244-1, underwriting data 1244-2, and/or claim/loss data 1244-4 in accordance with embodiments as described herein. Client data 1244-1, underwriting data 1244-2, and/or claim/loss data 1244-3 received via the input device 1214 and/or the communication device 1218 may, for example, be analyzed, sorted, filtered, decoded, decompressed, ranked, scored, plotted, and/or otherwise processed by the processor 1212 in accordance with the hazard grade determination instructions 1242-2. In some embodiments, client data 1244-1, underwriting data 1244-2, and/or claim/loss data 1244-3 may be fed by the processor 1212 through one or more mathematical and/or statistical formulas and/or models in accordance with the hazard grade determination instructions 1242-2 to inform and/or affect risk assessment processes and/or premium calculations, as described herein.

According to some embodiments, the underwriting instructions 1242-3 may be operable to cause the processor 1212 to process the client data 1244-1, underwriting data 1244-2, and/or claim/loss data 1244-3 in accordance with embodiments as described herein. Client data 1244-1, underwriting data 1244-2, and/or claim/loss data 1244-3 received via the input device 1214 and/or the communication device 1218 may, for example, be analyzed, sorted, filtered, decoded, decompressed, ranked, scored, plotted, and/or otherwise processed by the processor 1212 in accordance with the underwriting instructions 1242-3. In some embodiments, client data 1244-1, underwriting data 1244-2, and/or claim/loss data 1244-3 may be fed by the processor 1212 through one or more mathematical and/or statistical formulas and/or models in accordance with the underwriting instructions 1242-3 to cause, facilitate, inform, and/or affect underwriting product determinations and/or sales (e.g., based at least in part on hazard grade determinations) as described herein.

In some embodiments, the premium determination instructions 1242-4 may be operable to cause the processor 1212 to process the client data 1244-1, underwriting data 1244-2, and/or claim/loss data 1244-3 in accordance with embodiments as described herein. Client data 1244-1, underwriting data 1244-2, and/or claim/loss data 1244-3 received via the input device 1214 and/or the communication device 1218 may, for example, be analyzed, sorted, filtered, decoded, decompressed, ranked, scored, plotted, and/or otherwise processed by the processor 1212 in accordance with the premium determination instructions 1242-4. In some embodiments, client data 1244-1, underwriting data 1244-2, and/or claim/loss data 1244-3 may be fed by the processor 1212 through one or more mathematical and/or statistical formulas and/or models in accordance with the premium determination instructions 1242-4 to cause, facilitate, inform, and/or affect underwriting product premium determinations and/or sales (e.g., based at least in part on hazard grade determination) as described herein.

In some embodiments, the apparatus 1210 may function as a computer terminal and/or server of an insurance and/or underwriting company, for example, that is utilized to rate, price, quote, sell, and/or otherwise offer underwriting products such as insurance plans (e.g., based at least in part business classification/reclassification tiebreaking). In some embodiments, the apparatus 1210 may comprise a web server and/or other portal (e.g., an Interactive Voice Response Unit (IVRU)) that provides VED-based claim and/or underwriting product determinations and/or products to clients, such as via the interface 1220.

In some embodiments, the apparatus 1210 may comprise the cooling device 1250. According to some embodiments, the cooling device 1250 may be coupled (physically, thermally, and/or electrically) to the processor 1212 and/or to the memory device 1240. The cooling device 1250 may, for example, comprise a fan, heat sink, heat pipe, radiator, cold plate, and/or other cooling component or device or combinations thereof, configured to remove heat from portions or components of the apparatus 1210.

Any or all of the exemplary instructions and data types described herein and other practicable types of data may be stored in any number, type, and/or configuration of memory devices that is or becomes known. The memory device 1240 may, for example, comprise one or more data tables or files, databases, table spaces, registers, and/or other storage structures. In some embodiments, multiple databases and/or storage structures (and/or multiple memory devices 1240) may be utilized to store information associated with the apparatus 1210. According to some embodiments, the memory device 1240 may be incorporated into and/or otherwise coupled to the apparatus 1210 (e.g., as shown) or may simply be accessible to the apparatus 1210 (e.g., externally located and/or situated).

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A specially-programmed computerized processing device, comprising:
a computerized processor; and
a memory in communication with the processor, the memory storing specially-programmed instructions that when executed by the computerized processor result in:
receiving, from a user device, an indication of identifying information of a business for which an insurance product is sought;
determining a business classification of the business;
determining at least one available insurance policy type for the insurance product based on the business classification;
determining an initial hazard grade for the insurance product based on the business classification;
providing, to the user device, a plurality of underwriting questions based on the at least one available insurance policy type;
receiving, in response to the providing of the plurality of underwriting questions, at least one answer to the plurality of underwriting questions;
determining, based on the initial hazard grade and the at least one answer to the plurality of underwriting questions, a final hazard grade for the insurance product; and
determining a premium for the insurance product based on the final hazard grade.

2. The specially-programmed computerized processing device of claim 1, wherein the specially-programmed instructions, when executed by the computerized processor, further result in:
selling, to a customer, the insurance product based on the premium.

3. The specially-programmed computerized processing device of claim 1, wherein the identifying information of the business comprises at least one of a business name, annual sales data for the business, annual payroll data for the business, and a business location.

4. The specially-programmed computerized processing device of claim 1, wherein determining of the business classification is based on third-party data and the identifying information of the business.

5. The specially-programmed computerized processing device of claim 1, wherein receiving the at least one answer to the plurality of underwriting questions comprises receiving a respective answer for each of the plurality of underwriting questions.

6. The specially-programmed computerized processing device of claim 1, wherein determining, based on the initial hazard grade and the at least one answer to the plurality of underwriting questions, the final hazard grade for the insurance product comprises:
determining at least one hazard grade modification rule.

7. The specially-programmed computerized processing device of claim 6, wherein the specially-programmed instructions, when executed by the computerized processor, further result in:
determining an effect of the at least one answer on the initial hazard grade based on the at least one hazard grade modification rule.

8. The specially-programmed computerized processing device of claim 1, wherein determining, based on the initial hazard grade and the at least one answer to the plurality of underwriting questions, the final hazard grade for the insurance product comprises:
determining a final hazard grade score for the insurance product based on the initial hazard grade and the at least one answer to the plurality of underwriting question; and
determining the final hazard grade for the insurance product based on the final hazard grade score.

9. The specially-programmed computerized processing device of claim 8, wherein determining the final hazard grade for the insurance product based on the final hazard grade score comprises:
determining that the final hazard grade score is within a predetermined hazard grade score range corresponding to the final hazard grade.

10. The specially-programmed computerized processing device of claim 1,
wherein the at least one answer to the plurality underwriting questions comprises a first answer to a corresponding first underwriting question; and
wherein determining, based on the initial hazard grade and the at least one answer to the plurality of underwriting questions, the final hazard grade for the insurance product comprises:
determining a final hazard grade for the first question based on the first answer and a first hazard grade modification rule.

11. The specially-programmed computerized processing device of claim 10, wherein the specially-programmed instructions, when executed by the computerized processor, further result in:
determining a final hazard grade score for the first question based on the final hazard grade for the first question.

12. The specially-programmed computerized processing device of claim 11, wherein determining the final hazard grade score for the first question based on the final hazard grade comprises:
determining a default hazard grade score corresponding to the final hazard grade for the first question.

13. The specially-programmed computerized processing device of claim 10,
wherein the at least one answer to the plurality underwriting questions further comprises a second answer to a corresponding second underwriting question;
wherein determining, based on the initial hazard grade and the at least one answer to the plurality of underwriting questions, the final hazard grade for the insurance product comprises:
determining a final hazard grade score for the first question based on the final hazard grade,
determining a final hazard grade for the second question based on the second answer and a second hazard grade modification rule,
determining a final hazard grade score for the second question based on the second hazard grade, and
determining the final hazard grade for the insurance product based on the final hazard grade score for the first question and the final hazard grade score for the second question.

14. The specially-programmed computerized processing device of claim 13,
wherein the first underwriting question and the second underwriting question are associated with a first hazard grade category; and
wherein the specially-programmed instructions, when executed by the computerized processor, further result in:
determining a hazard grade score for the first hazard grade category based on the final hazard grade score for the first question and the final hazard grade score for the second question.

15. The specially-programmed computerized processing device of claim 14, wherein determining the hazard grade score for the first hazard grade category based on the final hazard grade score for the first question and the final hazard grade score for the second question comprises:
calculating an average hazard grade score for the first hazard grade category based on the final hazard grade score for the first question and the final hazard grade score for the second question.

16. The specially-programmed computerized processing device of claim 1, wherein determining, based on the initial hazard grade and the at least one answer to the plurality of underwriting questions, the final hazard grade for the insurance product comprises:
determining a first hazard grade score for a first hazard grade category;
determining a second hazard grade score for a second hazard grade category;
determining a first hazard grade category weight associated with the first hazard grade category;
determining a second hazard grade category weight associated with the second hazard grade category;
calculating a final hazard grade score for the insurance product by multiplying the first hazard score by the first hazard grade category weight and multiplying the second hazard score by the second hazard grade category weight; and
determining the final hazard score based on the calculated final hazard grade score.

17. The specially-programmed computerized processing device of claim 1, wherein the final hazard grade comprises a ranking indicative of a level of risk.

18. The specially-programmed computerized processing device of claim 1, wherein the insurance product comprises an errors and omissions policy type.

19. The specially-programmed computerized processing device of claim 1, wherein determining the premium for the insurance product based on the final hazard grade comprises:
determining a base rate for the insurance product based on the final hazard grade.
